(19) United States
(12) Patent Application Publication
(10) Pub. No.: US 2001/0005837 A1
(43) Pub. Date: Jun. 28, 2001

(54) Terminal apparatus, server apparatus, and recording medium

(76) Inventor: Takashi Kojo, Tokyo (JP)

Correspondence Address: FRISHAUF, HOLTZ, GOODMAN,, LANGER & CHICK, P.C., 25th Floor, 767 Third Avenue, New York, NY, 10017, US

(21) Appl. No.: 09/748,939

(22) Filed: Dec. 27, 2000

(30) Foreign Application Priority Data
Dec. 28, 1999 (JP) 11-374626
Sep. 7, 2000 (JP) 2000-271961

(51) Int. Cl. G06F 17/60

(52) U.S. Cl. 705/51

(57) ABSTRACT

The present invention is capable of appropriately rejecting to receive data transmitted as a present via network. A terminal apparatus can receive present data transmitted from a terminal apparatus via a network. The terminal apparatus presets a rejection condition for rejecting the reception of present data transmitted from a sender by user setting processing with a present reception rejection processing program. At the time of receiving present data, the terminal apparatus executes present rejection processing with the present reception rejection processing program to determine whether or not present data corresponds to the rejection condition. When present data corresponds to the rejection condition, the terminal apparatus rejects the reception of present data and notifies the sender that the reception has been rejected.

### BACKGROUND OF THE INVENTION

1. Field of the Invention

The present invention relates to a terminal apparatus for distributing data of various kinds such as music data, image data, voice data, program data and the like as a present, a server apparatus, and a recording medium having a reception rejection processing program recorded therein in the field of data distribution service using a communication network.

2. Description of the Related Art

In recent years, distribution service of various data using a communication network such as the Internet has been put to practical use. For example, data of various kinds such as a computer program, news, a weather forecast, a book, music, a move, a photograph, etc., can be distributed as character data, image data, or voice data.

Distribution service of such data is offered at cost or no cost by a service provider. In any case, according to data distribution request (order) to a specified service site from a computer terminal accessible to the network, data received by a server on the service site in response to the request is allowed to be downloaded or is transmitted as a mail so that desired data is distributed to a user of request source (computer terminal).

Thus, conventional data distribution service is designed to distribute data requested by the user terminal to the user. The user, however, has the need in which the user not only enjoys data of music, move, etc. by oneself but also wishes to send it to a third party's computer terminal as a present.

While, the third party to which music data and like as a present are to be sent wants to reject the reception in some cases, for example, one case in which the present is one that the third party wishes to have; and other case in which the third party feels hesitant to receive data since the data has been obtained at high cost. However, in the conventional data distribution service, it is impossible to appropriately reject to receive data sent as a present.

For example, in a case of transmitting data as a present via the network, data can be transmitted as e-mail attachment file. In this case, a mail recipient notices that expensive music data is attached thereto only after opening the mail. The mail can be deleted without opening the attachment file of music data, but resultantly, the recipient has received music data as a present sent by the communication partner. Thus, in the current system in which the present is sent via the network, the receiver side cannot reject to receive the present and this often causes trouble to the receiver.

### SUMMARY OF THE INVENTION

The present invention has been made with consideration taken to the above-mentioned problem, and it is an object of the present invention is to provide a terminal apparatus capable of rejecting to receive data as a present sent via a network appropriately, a server apparatus, and a recording medium having a reception rejection processing program recorded therein.

In order to attain the above object, according to the present invention, there is provided a terminal apparatus, which receives data transmitted from a sender via a network, comprising extracting means for extracting data of a predetermined format among from data transmitted from said sender; rejection condition setting means for storing a rejection condition for rejecting the reception of the extracted data of the predetermined format by the extracting means; determining means for determining whether or not the reception of the extracted data is rejected based on the rejection condition set by the rejection condition setting means; and rejecting means for rejecting the reception of the extracted data transmitted from the sender when the reception of the extracted data is rejected by said determining means.

### BRIEF DESCRIPTION OF THE DRAWINGS

These objects and other objects and advantages of the present invention will become more apparent upon reading of the following detailed description and the accompanying drawings in which:

FIG. 1 is a block diagram showing a system configuration according to an embodiment of the present invention;

FIG. 2 is a block diagram showing an electronic circuit configuration of a terminal apparatus 14 as a present destination;

FIG. 3 is a flowchart to explain user setting processing of a present rejection condition table;

FIG. 4 is a flowchart to explain present rejection processing;

FIG. 5 is a flowchart to explain present rejection processing;

FIG. 6 is a view showing one example of a screen page for setting a present rejection condition table;

FIG. 7 is a view showing one example of a screen page for setting a kind name table;

FIG. 8 is a view showing a specific example in which present data is transmitted by an e-mail attachment file;

FIG. 9 is a view showing a specific example in which present data is transmitted by an e-mail attachment file;

FIG. 10 is a view showing a specific example in which present data is transmitted by an e-mail attachment file;

FIG. 11 is a view showing a specific example of a return mail to be returned when a reception of present data is rejected;

FIG. 12 is a view showing a specific example of a return mail to be returned when a reception of present data is rejected;

FIG. 13 is a view showing a specific example of a return mail to be returned when a reception of present data is rejected;

FIG. 14 is a block diagram showing an electronic circuit configuration of a mail server 18;

FIG. 15 is a block diagram showing an electronic circuit configuration of a sender's (present source) terminal apparatus 12;

FIG. 16 is a block diagram showing an electronic circuit configuration of a present distribution server 16;

FIG. 17 is flowchart showing an operation of each of the terminal apparatus 12 and the present distribution server 16;

FIG. 18 is a flowchart showing an operation of the terminal apparatus 14;

FIG. 19 is a block diagram showing an electronic circuit configuration of a music distribution server according to a fourth embodiment of the present invention;

FIG. 20 is a view showing an example of music transmission data in a music transmission data memory of the music distribution server;

FIG. 21 is a flowchart showing sender handling processing (1) performed by the music distribution server;

FIG. 22 is a flowchart showing sender handling processing (2) performed by the music distribution server;

FIG. 23 is a flowchart showing destination handling processing (1) performed by the music distribution server; and

FIG. 24 is a flowchart showing destination handling processing (2) performed by the music distribution server;

### DETAILED DESCRIPTION OF THE PREFERRED EMBODIMENTS

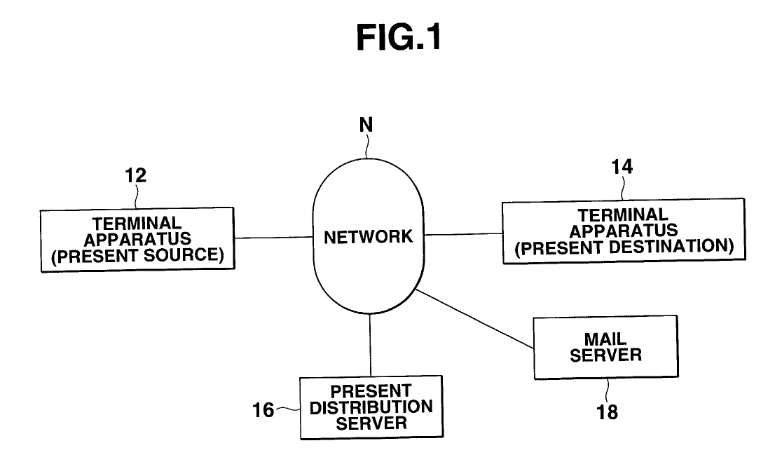

FIG. 1 is a block diagram showing a system configuration according to an embodiment of the present invention. As shown in FIG. 1, a terminal apparatus 12 (present source), serving as a present sending source, a terminal apparatus 14 (present destination), serving as a destination where a present is sent, a present distribution server 16 that distributes various kinds of data to a predetermined destination in accordance with a request from a user, and a server 18 that manages e-mail transmitted/received by the terminal apparatus 14 are connected to one another via a network N having the Internet, a public switches telephone network and the like.

The following will explain a first embodiment, a second embodiment, and a third embodiment in order. In the first embodiment, processing (present rejection processing to be described later) for rejecting the reception of data is executed to data transmitted to the terminal apparatus 14 as a present destination from the terminal apparatus 12 at the terminal apparatus 14. In the second embodiment, present rejection processing is executed to an attachment file (data) attached to e-mail to be sent to the terminal apparatus 14 at the mail server 18. In the third embodiment, the present distribution server 16 transmits data to the terminal apparatus 14 in accordance with the request of data transmission from the terminal 12 and executes processing to the data in accordance with whether the terminal apparatus 14 receives data or rejects.

### First Embodiment

An explanation is first given of the first embodiment.

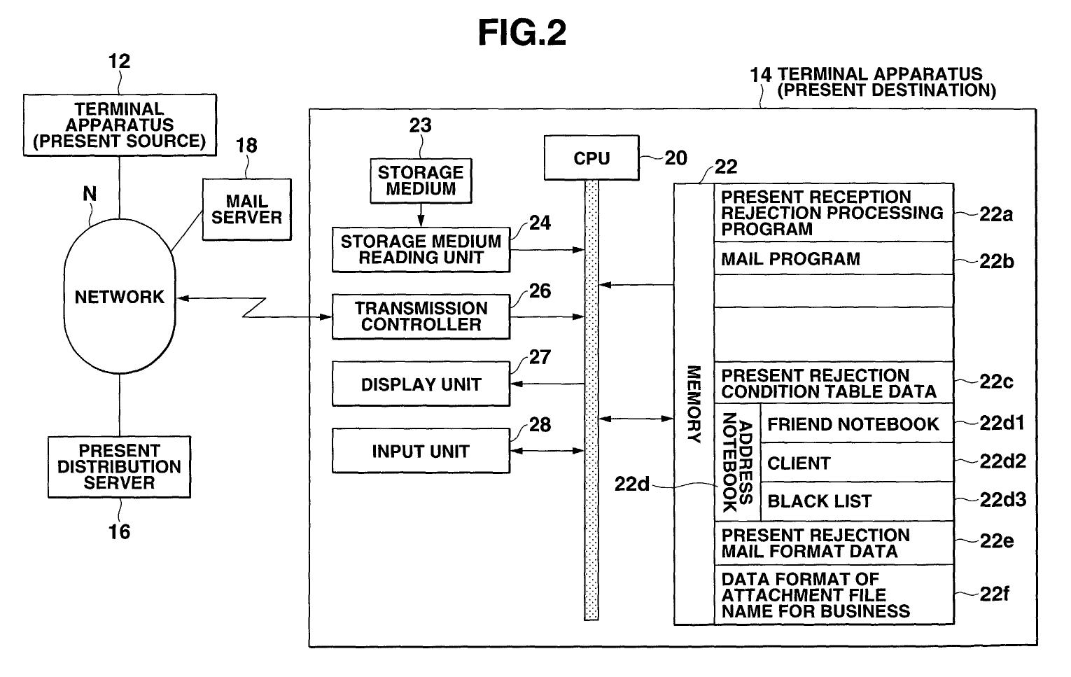

FIG. 2 is a block diagram showing an electronic circuit configuration of the terminal apparatus 14 as a present destination.

As shown in FIG. 2, the terminal apparatus 14 has a CPU 20, a memory 22, a storage medium 23, a storage medium reading unit 24, a transmission controller 26, and an input unit 28.

The CPU 20 controls an operation of each of the respective parts of the circuit in accordance with a program stored in the memory 22 using a hard disk or a flash memory (EEPROM), a program fetched from the storage medium 23 via the storage medium unit 24, or a program fetched from the computer terminal connected to an external communication network N via the transmission controller 26. The program executed by the CPU 20 is started according to access from other terminal apparatuses communicated via the transmission controller 16 or a manual control input from the input unit 28 having a keyboard, a mouse and the like.

The CPU 20 connects with the memory 22, the storage medium reading unit 24, the transmission controller 26, a display unit 27, and the input unit 28.

The memory 22 stores a mail program 22b and a present reception rejection processing program 22a for executing user setting processing, which is performed with mail processing executed based on the mail program 22b, and present rejection processing. The memory 22 also stores present rejection condition table data 22c registered by user setting processing, address notebook data 22d (including friend notebook data 22d1, client data 22d2, black list data 22d3) which are used at the time of present rejection processing, present rejection mail format data 22e, data format 22f of an attachment file name for business as required. Additionally, the memory 22 reserves a work area for storing data, which needs temporary storage depending on the operations of processing functions of various kinds.

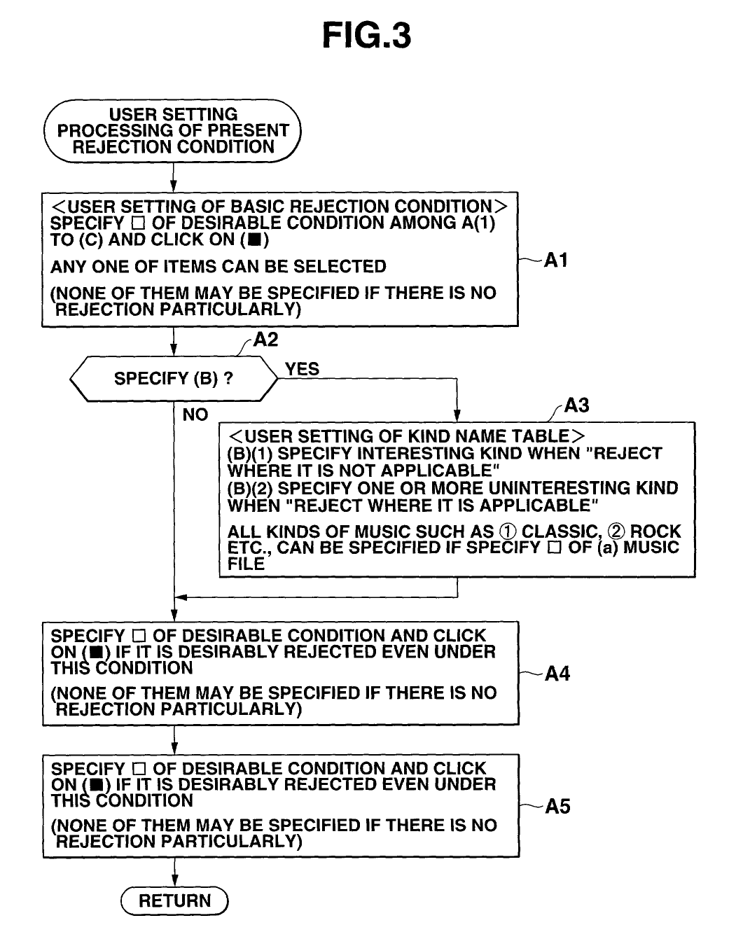

First, user setting processing of the present rejection condition table is explained with reference to the flowchart of FIG. 3.

The terminal apparatus 14 pre-executes user setting processing of the present rejection condition table to set a rejection condition. When data (present data) sent from the third person corresponds to a rejection condition, the terminal apparatus 14 can reject the reception of present data appropriately by present rejection processing.

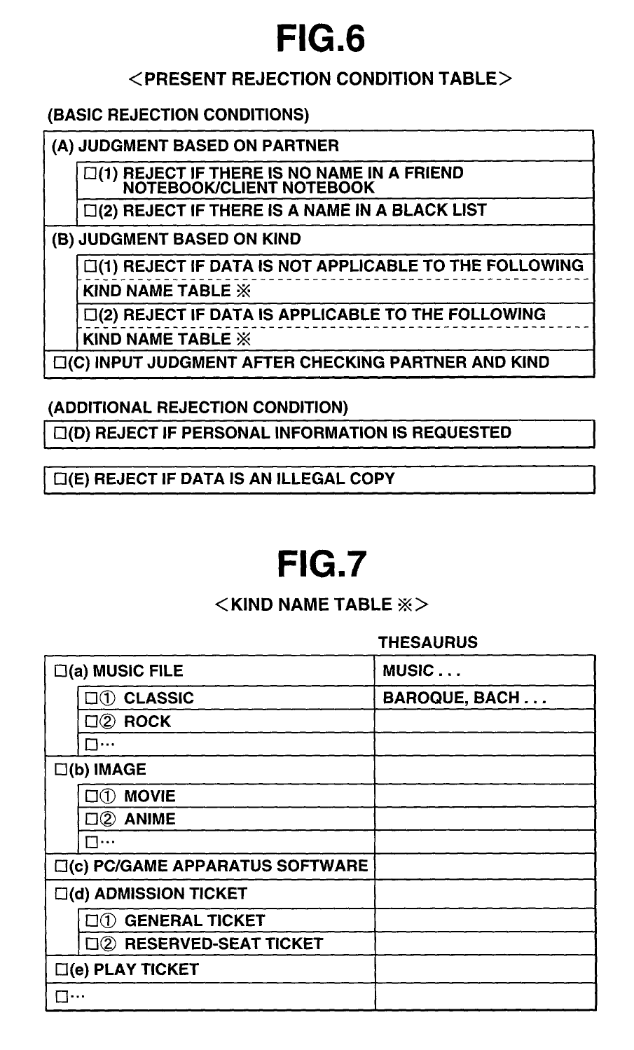

When the user inputs a setting request for present rejection condition, the CPU 20 of terminal apparatus 14 runs the present reception rejection processing program 22a and starts user setting processing of present rejection condition table to display a screen page for the present rejection condition table setting. On the setting screen page, a plurality of items that can set basic rejection conditions and additional rejection conditions is prepared as shown in FIG. 6. The basic rejection conditions provide items that can select “(A) judgment based on a communication partner”, “(B) judgment based on a kind of data”, and “(C) judgment based on a communication partner and a kind of data” (hereinafter referred to as rejection conditions (A), (B), (C), respectively). In the case of setting a basic rejection condition, any one of rejection conditions (A), (B), and (C) can be selected.

The rejection condition (A) includes selective items, that is, “(1) reject if there is no name in a friend notebook/client notebook” and “(2) reject if there is a name in a black list” (hereinafter referred to as basic rejection conditions (A)(1) and (A)(2), respectively). The basic rejection condition (A)(1) specifies rejection of data when the data is sent from a communication partner who is not registered in the address notebook 22d (including friend notebook data 22d1 and client data 22d2) in which friends and clients are pre-registered by the user. The basic rejection condition (A)(2) specifies rejection of data when the data is sent from a communication partner who is registered in the black list data 22d3 in which communication partners from whom the user should reject to receive data are pre-registered by the user.

The rejection condition (B) includes selective items, that is, “(1) reject where data is not applicable to the following” and “(2) reject where data is applicable to the following” (hereinafter referred to as basic rejection conditions (B)(1) and (B)(2), respectively). The basic rejection condition (B)(1) specifies rejection of data when the data is not applicable to a content of present data set by a kind name table to be described later. The basic rejection condition (B)(2) specifies rejection of data when the data is not applicable to a content of present data set by the kind name table.

As shown in FIG. 7, the kind name table can specify “(a) music file” indicative of a kind of music, “(b) image” indicative of a kind of image, “(c) PC/game apparatus software” indicative of software for a personal computer (PC) and a game apparatus, “(d) admission ticket” indicative of an admission ticket for a movie, a theater, and the like, and “(e) play ticket” that can be used at an amusement arcade (hereinafter referred to as kind names (a), (b), ...). Moreover, the kind name (a) can arbitrarily specify “\mathring{1} classic”, “ \mathring{2} rock”, . . . , which are kinds of music. Similarly, the kind name (b) can arbitrarily specify “\mathring{1} movie”, “\mathring{2} anime”, . . . , which are kinds of music. The kind name (d) can specify “\mathring{1} general ticket”, and “\mathring{2} reserved-seat ticket.”

The basic rejection condition (C) can specify that the user determine data sent from the communication partner after checking the partner as a sender and the kind of present data.

The additional rejection condition includes selective items, that is, “(D) reject when input of personal information is requested” and “(E) reject when data is illegal copied” (hereinafter referred to as additional rejection conditions (D) and (E), respectively). The additional rejection condition (D) specifies rejection of data when transmission of personal information of such as a name, an address, etc., is requested in exchange for present data. The additional rejection condition (E) specifies rejection of data when it is detected that present data is data that is illegally copied. One or both of additional rejection conditions (D) and (E) can be optionally selected when setting additional rejection conditions.

First, the terminal apparatus 14 inputs the user setting of basic rejection condition sent from the user (step A1). When a desirable condition item is specified among the basic rejection conditions (A) to (C), which are prepared as basic rejection conditions, a check box of the corresponding item is clicked on. Any one of items can be selected in setting the basic rejection conditions. When there is no present data as an object to be rejected, none of them may be specified.

It is assumed that the basic rejection condition (B) is selected to specify that data be determined by the kind of present data (step A2). The terminal apparatus 14 displays a page screen for a kind name table setting and inputs user setting (step A3). Here, it is assumed that basic rejection condition (B)(1) or (B)(2) is selected and specification of at least one selective item of the kind name table is input. Regarding specification to the kind name table, a kind of specific present data may be selected, for example, by a kind of music as in kind names (a) “\mathring{1}classic”, “\mathring{2}rock.” Or, all kinds of music can be specified as an object by checking the music file of kind name (a). Regarding the image of kind name (b), the program of kind name (c), the admission ticket of kind name (d) and the play ticket of kind name (e), they can be specified in the same as the above.

Moreover, (D) or (E) can be specified as an additional rejection condition (step A4, A5). When the additional rejection condition (D) or (E) is specified, the terminal apparatus 14 clicks on a check box of the corresponding item. When there is no rejection item with respect to the additional rejection conditions, none of them may be specified.

Thus, since the rejection condition specified by the user using in user setting processing is read when present rejection processing is performed to present data, such a rejection condition is stored in the memory 22 as present rejection condition table data 22c.

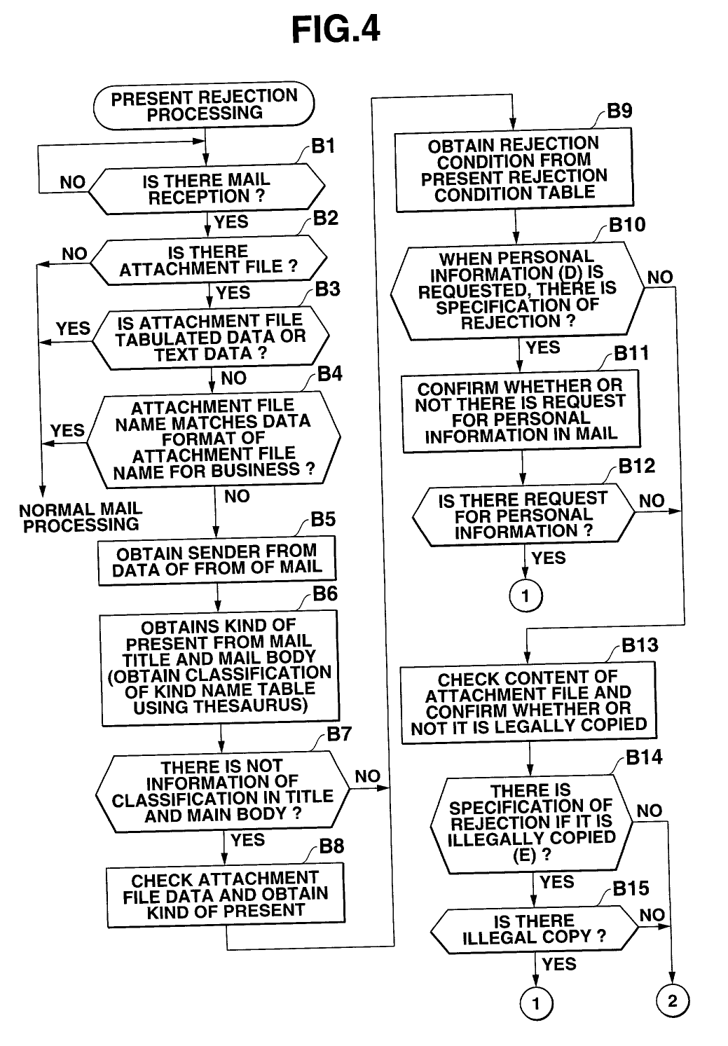

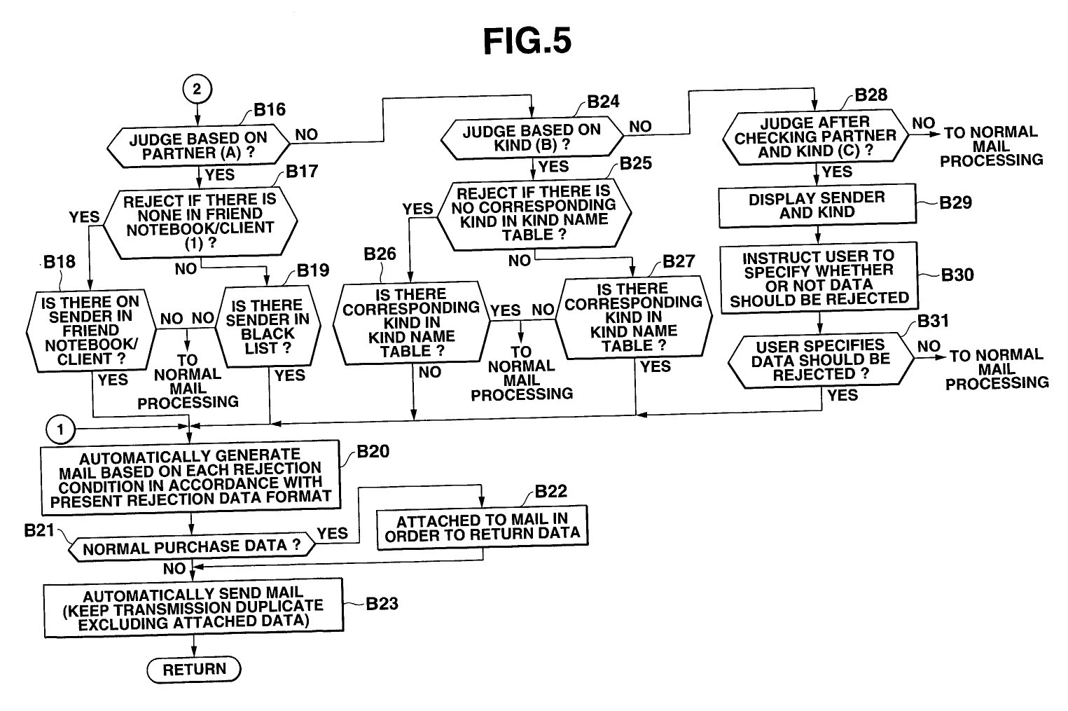

An explanation is next given of present rejection processing with reference to flowcharts of FIGS. 4 and 5. This embodiment is explained on the assumption that an e-mail attachment file is used as a method for transmitting present data to the present destination terminal apparatus 14 from the sender's terminal apparatus 12.

The CPU 20 of terminal apparatus 14 executes the present reception rejection processing program 22a when e-mail is received in accordance with the execution of mail program 22b, whereby performing present rejection processing to the attachment file (present file) attached to the received mail.

When there is a mail reception (step B1), the terminal apparatus 14 determines whether or not an attachment file is attached to the received mail (step B2). When the attachment file is attached thereto, the terminal apparatus 14 determines whether the kind of the attachment file is tabulated data or text data with reference to, for example, a file extension (step B3). Tabulated data or text data is file data, which is generally used, namely, tabulated data or text data is not regarded as present data, and an operation goes to normal mail processing.

When the attachment file is neither tabulated data nor text data (step B3), the terminal apparatus 14 determines whether or not an attachment file name matches the data format 22f of the attachment file name for business stored in the memory 22 beforehand (step B4). When the attachment file name matches data format 22f of the attachment file name for business, the attachment file is the attachment for business, namely, the attachment file is not regarded as present data, and an operation goes to normal mail processing. The data format 22f of the attachment file name for business indicates a file format of a file generated by a word processing software, a spreadsheet software, a presentation software (for example, Microsoft (R) PowerPoint (R)), a document viewer software (for example, Adobe (R) Acrobat (R)), and the like, those are used by a user for business purpose. This makes it possible to remove data other than the present data, for example, a business-related attachment file transmitted as merely information or business material. Namely, this makes it possible to prevent unnecessary processing in which, for example, a content of file is displayed and confirmed by the user when the kind of data transmitted as an attachment file cannot be determined by determination of a kind of content of the present performed in step B8 to be described later.

While, when the attachment file is determined as present data, the terminal apparatus 14 obtains a sender of the present (mail address) based on “FROM” data indicative of a mail sender address (step B5). The terminal apparatus 14 also obtains a kind of present data based on a mail title (TITLE) and data of a mail body (step B6).

In obtaining the kind of present data, a thesaurus registering a plurality of words relating to the kind therein is provided to each of the kinds prepared in the kind name table as shown in, for example, FIG. 7. The kind of present data is determined by searching the thesaurus using a word extracted from the mail tile or mail body. For example, in the thesaurus, synonym words such as “music”, etc., are registered with respect to the kind of “music file”, the words such as “baroque”, “Bach” etc., are registered with respect to the “classic.” When the words “music”, “Bach” and the like are included in the mail body, since it is searched that these words correspond to the “music file” and “classic” in the kind name table, it is determined that the kind of present data is a music file.

The kind of present data may be determined by various kinds of methods wherein such as the frequency of occurrence of the words registered in the thesaurus is counted, or the words occurred are combined, or the word included in the title is determined higher priority.

When there is no information of the kind of present in the title or the main body, the attachment file data is checked to obtain the kind of present (step B8). Here, the attachment file is opened by executing a viewer program (not shown) to display the content of file to be confirmed by the user.

Next, the terminal apparatus 14 (CPU 20) reads present rejection condition table data 22c pre-registered in the memory 22 to obtain a rejection condition (step B9). In this case, when the additional rejection condition (D) is set in the present rejection condition table (step B10), the terminal apparatus 14 determines whether or not data requesting personal information is added to the mail (step B11). When data requesting personal information is added to the mail, the terminal apparatus 14 obtains present rejection mail format data 22e corresponding to the additional rejection (D), automatically generates a mail in accordance with the present rejection data format (step B20), and automatically send the mail for notifying that the reception of present data is rejected (step B23). If present data is one that is not normally purchased at cost, the terminal apparatus 14 determined that the return of present data is unnecessary (step B21).

While, when the received mail does not request personal information, the terminal apparatus 14 checks the content of the attachment file to confirm whether or not the attachment file is data that is legally copied (data that is normally purchased) (step B13). For example, electronic data sold as computer program works includes an “electronic watermark” to protect an illegal copied. The confirmation of this “electronic watermark” makes it possible to check whether the content of the attachment file is data that is normally purchased or data that is illegally copied. It is possible to check whether or not the content of the attachment file is data that is illegally copied by the other method.

Here, in a case where the additional condition “(E) reject when data is illegal copied” is set as the rejection condition (step B14), the terminal apparatus 14 obtains present rejection mail format data 22e, which corresponds to the additional rejection condition (E) when data is determined as an illegal copy (step B15). Then, the terminal apparatus 14 automatically generates a mail in accordance with this present rejection data format (step B20), and automatically send the mail for notifying that the reception of present data is rejected (step B23). In this case, since the present data of attachment file is not data that is normally purchased, the terminal apparatus 14 abandons the present data without returning it to the present source (step B23).

Moreover, when the basic rejection condition (A)(1) is set (steps B16, B17), the terminal apparatus 14 confirms whether or not the sender mail address previously obtained is registered in the friend notebook 22d1 or client 22d2 of the address notebook 22d (step B18). When the sender mail address is not registered in the friend notebook 22d1 or client 22d2, the terminal apparatus 14 determined that the present mail corresponds to the rejection condition and that it should be rejected to receive, and automatically generates a mail in accordance with this present rejection data format (step B20), and automatically send the mail for notifying that the reception of present data is rejected (step B23). While, when the sender mail address is registered in the friend notebook 22d1 or client 22d2, the terminal apparatus 14 shifts the operation to normal mail processing and obtains present data transmitted as an attachment file.

When the basic rejection condition (A)(2) is set (steps B16, B17), the terminal apparatus 14 confirms whether or not the sender mail address previously obtained is registered in the black list 22d3 of the address notebook 22d (step B19). When the sender mail address is registered in the black list 22d3, the terminal apparatus 14 determined that the present mail corresponds to the rejection condition and that it should be rejected to receive, and obtains present rejection mail format data 22e corresponding to the rejection condition (A)(2). Then, the terminal apparatus 14 automatically generates a mail in accordance with this present rejection data format (step B20), and automatically send the mail for notifying that the reception of present data is rejected (step B23). While, when the sender mail address is not registered in the black list 22d3, the terminal apparatus 14 shifts the operation to normal mail processing and obtains present data transmitted as an attachment file.

When the basic rejection condition (B)(1) is set (steps B24, B25), the terminal apparatus 14 confirms whether or not the kind of present data previously obtained corresponds to the kind specified in the kind name table (step B25). When the kind of present data is not specified in the kind name table (step B26), the terminal apparatus 14 determined that the present mail corresponds to the rejection condition and that it should be rejected to receive, and obtains present rejection mail format data 22e corresponding to the rejection condition (B)(1). Then, the terminal apparatus 14 automatically generates a mail in accordance with this present rejection data format (step B20), and automatically send the mail for notifying that the reception of present data is rejected (step B23). While, when the kind of present data is specified in the kind name table, the terminal apparatus 14 shifts the operation to normal mail processing and obtains present data transmitted as an attachment file.

When the basic rejection condition (B)(2) is set (steps B24, B25), the terminal apparatus 14 confirms whether or not the kind of present data previously obtained corresponds to the kind specified in the kind name table (step B25). When the kind of present data is specified in the kind name table (step B27), the terminal apparatus 14 determined that the present mail corresponds to the rejection condition and that it should be rejected to receive, and obtains present rejection mail format data 22e corresponding to the rejection condition (B)(2). Then, the terminal apparatus 14 automatically generates a mail in accordance with this present rejection data format (step B20), and automatically send the mail for notifying that the reception of present data is rejected (step B23). While, when the kind of present data is not specified in the kind name table, the terminal apparatus 14 shifts the operation to normal mail processing and obtains present data transmitted as an attachment file.

When the basic rejection condition (C) is set (steps B28), the terminal apparatus 14 displays the sender (mail address, name and the like) and the kind of present data to provide them to the user (step B29), and instructs the user to specify whether present data should be rejected to received or received (step B30). Here, when the user inputs specification to reject the reception of present, the terminal apparatus 14 obtains present rejection mail format data 22e corresponding to the rejection condition (C). Then, the terminal apparatus 14 automatically generates a mail in accordance with this present rejection data format (step B20), and automatically send the mail for notifying that the reception of present data is rejected (step B23). While, when the user inputs specification to receive the present, the terminal apparatus 14 shifts the operation to normal mail processing and obtains present data transmitted as an attachment file.

In this way, present rejection processing is executed with respect to present data transmitted as an e-mail attachment file, making it possible to reject to receive present data corresponding to the rejection condition preset.

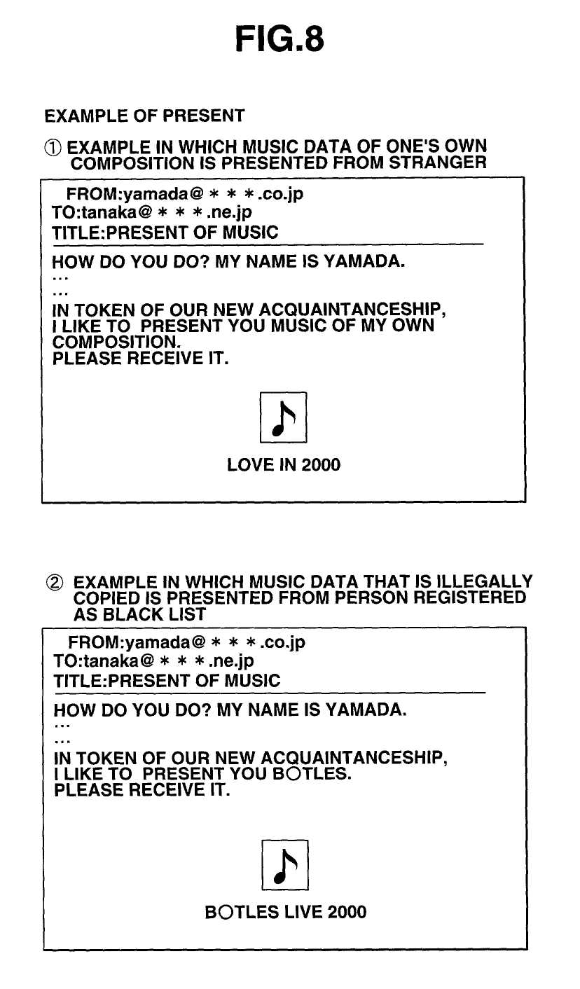

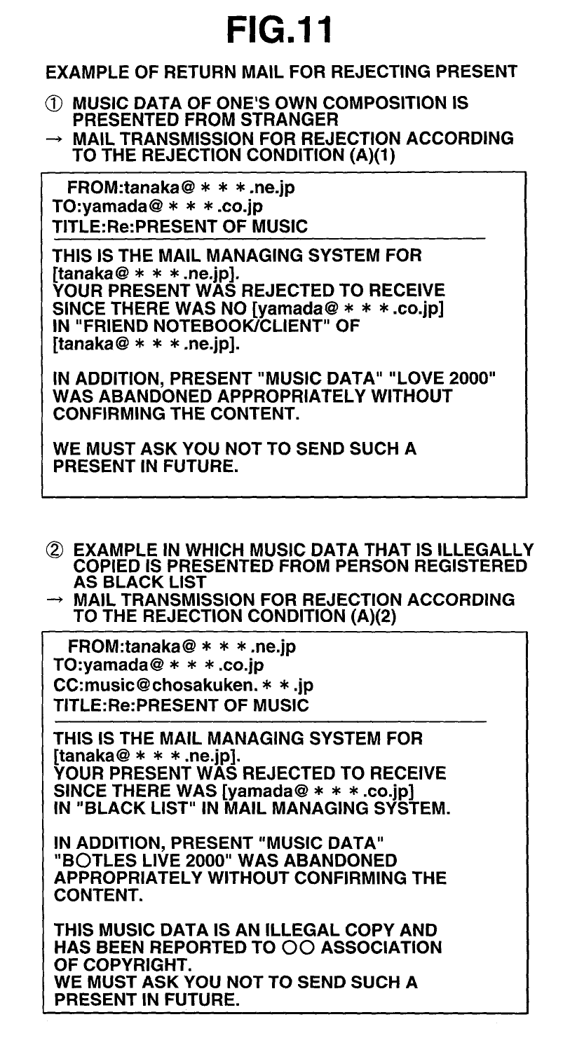

Hereinafter, FIGS. 8 to 10 show specific examples in which present data is transmitted as an e-mail attachment file and FIGS. 11 to 13 show specific examples in which the reception of each present data is rejected.

FIG. 8\mathring{1} shows an example in which music data of one's own composition (data obtainable at no charge) is presented from a complete stranger. The present source of this data can be obtained from a mail address “FROM” of the e-mail sender. In this case, if the basic rejection condition (A)(1) is specified, the music data is determined as data that should be rejected to receive since this is the mail sent from the person whom the user does not know and the sender mail address is not registered in the friend notebook data 22d1 and client data 22d2 of the address notebook data 22d. The terminal apparatus 14 generates a return mail according to the rejection condition (A)(1) as shown in FIG. 11\mathring{1} and sends it to the present source.

FIG. 8\mathring{2} shows an example in which music data that is illegally copied is presented from the communication partner registered as black list data 22d3. The present source of this data can be obtained from the mail address “FROM” of the e-mail sender. In this case, if the basic rejection condition (A)(2) is specified, the music data is determined as data that should be rejected to receive since the sender mail address is registered in the black list data 22d3 of address notebook data 22d. Moreover, when the additional condition (E) is specified and the attachment file data is confirmed as an illegal copy by present rejection processing, the terminal apparatus 14 generates a return mail as shown in FIG. 11\mathring{2} according to the rejection condition (A)(2) to send it to the present source, and abandons the attachment file such that the present source is not obtained again. In this case, the terminal apparatus 14 may generate e-mail to a predetermined contact address (“such and such Association of Copyright”) present rejection processing as shown in the mail body of FIG. 11\mathring{2} to provide notification in which the illegal copy has been found out.

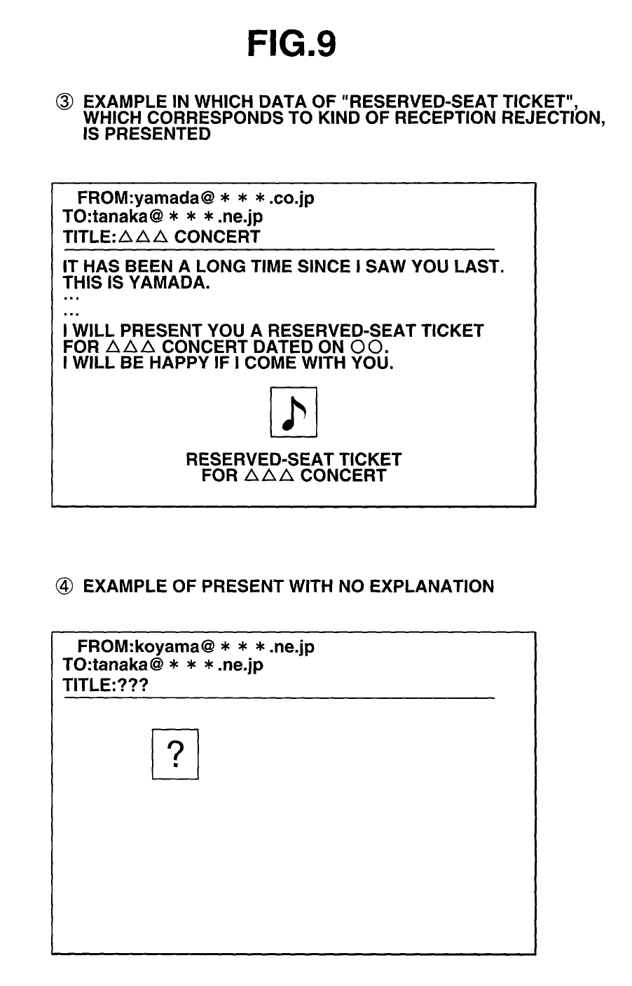

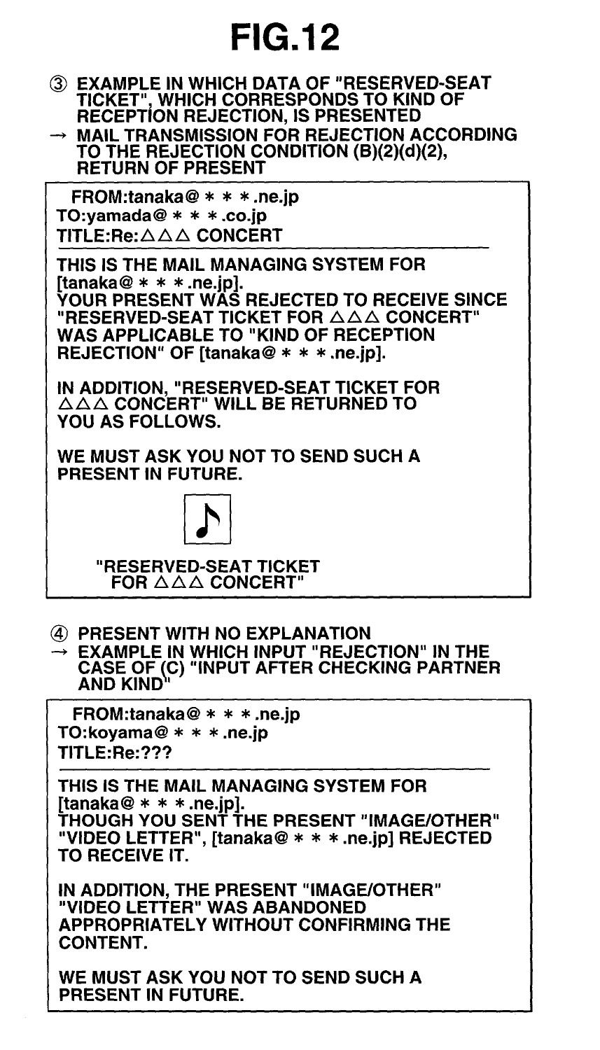

FIG. 9\mathring{3} shows an example in which data of “reserved-seat ticket” (data obtained at charge), which corresponds to the kind of reception rejection, is presented. The present data as e-mail can be identified as an admission ticket for a concert, which is a reserved-seat ticket from the message of the mail body. In this case, specification of the basic rejection condition (B)(2) and that of (d)\mathring{2} in the kind name table make it possible to reject data in the case of the admission ticket relating to the reserved-seat ticket and to receive data in the other cases. The terminal apparatus 14 generates a return mail as shown in FIG. 12\mathring{3} according to the rejection condition (B)(2) to send it to the present source, and returns this data as an attachment file.

FIG. 9\mathring{4} shows an example in which data with no explanation of an attachment file is presented. In this case, specification of the basic rejection condition (C) makes it possible to input specification of reception rejection after confirming the sender and the kind of data and not to reject the reception. The terminal apparatus 14 generates a return mail as shown in FIG. 12\mathring{4} according to the basic rejection condition (C) to send it to the present source.

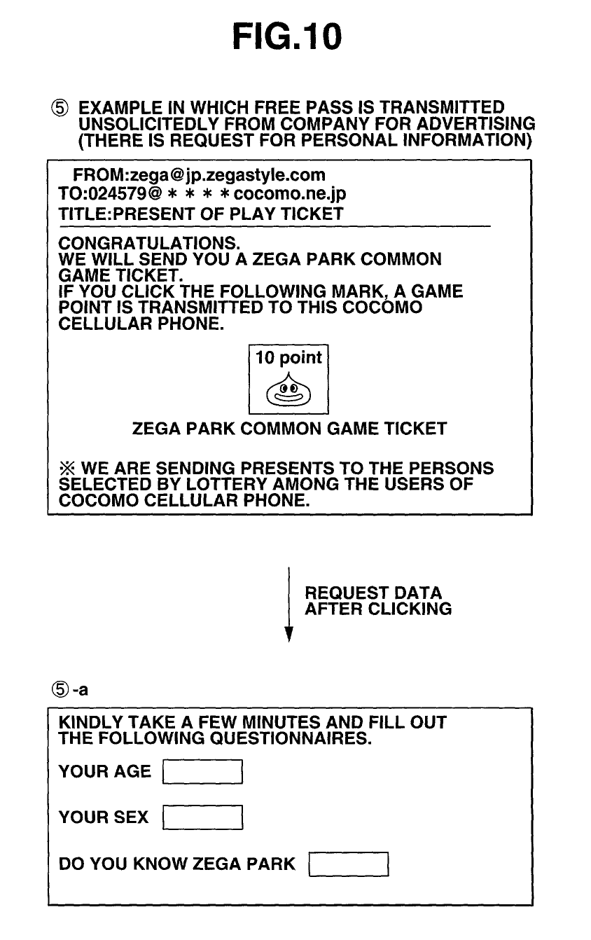

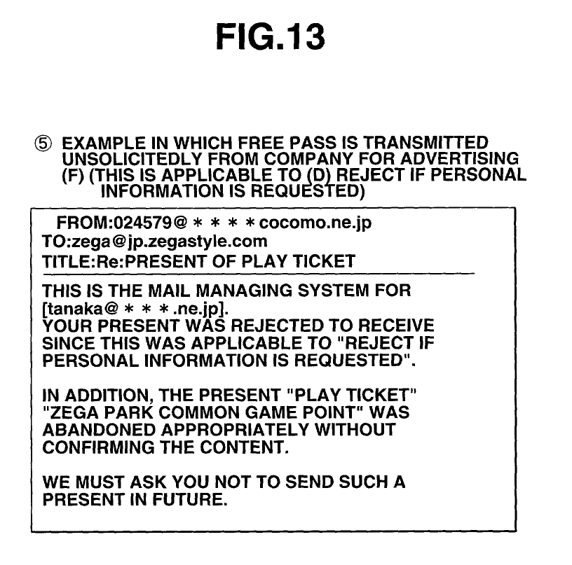

FIG. 10\mathring{5} shows an example in which a free pass that can be used at the amusement arcade is transmitted unsolicitedly from a company for the purpose of advertising. When an operation for obtaining data (click of a mark) is made, this e-mail requests questionnaires urging the use to input personal information as shown in FIG. 10 \mathring{5}-a. In this case, specification of the additional rejection condition (D) makes it possible to reject the reception when personal information is required. The terminal apparatus 14 generates a return mail as shown in FIG. 13\mathring{5} according to the additional rejection condition (D) to send it to the present source, and abandons the present data since it is not normally purchased.

The examples of present data shown in FIGS. 8 to 10, e-mail is opened and displayed to simplify the explanation. However, in present rejection processing, the basic rejection condition (C) is not specified, e-mail is not opened by the user's instruction. If the content is confirmed when e-mail is received and the content corresponds to the rejection condition, the reception may be rejected so that e-mail is not opened by the user. Moreover, only the mail body of e-mail can be opened and the attachment is designed not to be opened. Furthermore, present rejection processing displays only the kind of data to confirm the content and locks the attachment file such that other processing (copy and the like) is not performed even if the basic rejection situation (C) is specified. Thus, when the present reception rejection processing program 22a is installed on the terminal apparatus 14 to execute present rejection processing, it is possible to assure the third person that data rejected to receive is not received at the present destination.

Thus, according to the first embodiment, the terminal apparatus 14 at the present destination executes present rejection processing, whereby making it possible to appropriately reject data transmitted as a present from the terminal apparatus 12 using the e-mail attachment file in accordance with the rejection condition preset by user setting processing. Regarding the rejection condition, as explained using FIGS. 6 and 7, various kinds of conditions can be arbitrarily set to meet a user's desire. This makes it possible to recognize data to be rejected to receive without fail and to pay appropriate attention to the present source not to give an impolite impression thereto when present data is accidentally returned thereto.

### Second Embodiment

The second embodiment is next explained.

The first embodiment explained that present rejection processing was executed at the terminal apparatus 14 as a present source. However, in the second embodiment, the mail server 18, which manages e-mail to the terminal apparatus 14 as a present source, executes present rejection processing (FIGS. 4, 5).

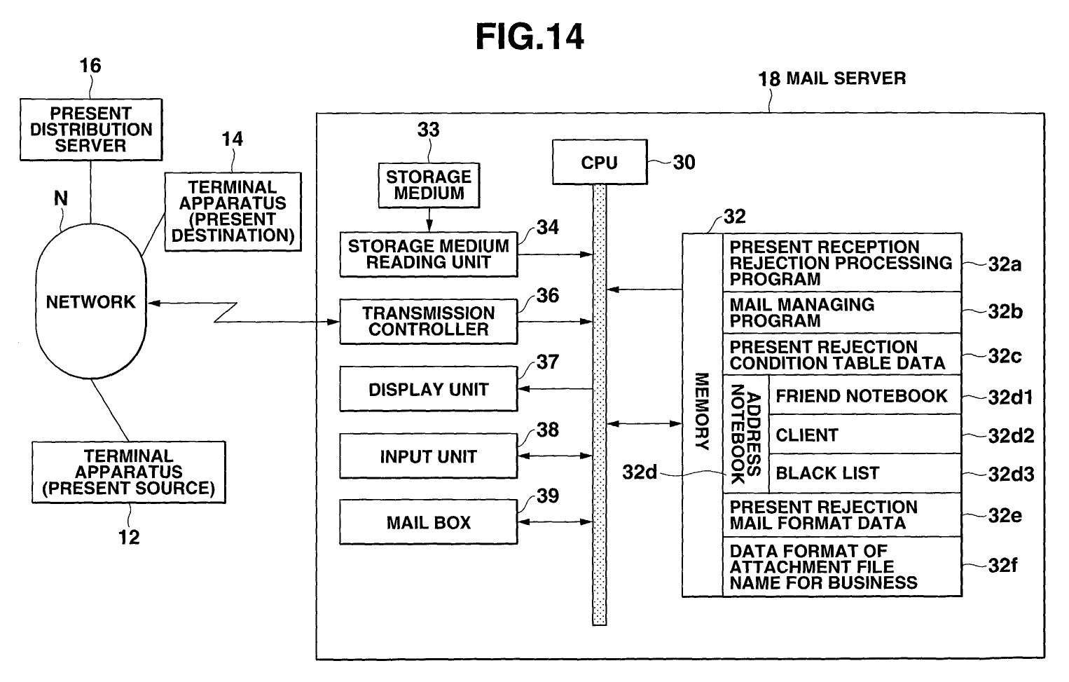

FIG. 14 is a block diagram showing the electronic circuit configuration of mail server 18. As shown in FIG. 14, the mail server 18 has a CPU 30, a memory 32, a storage medium 33, a storage medium reading unit 34, a transmission controller 36, a display unit 37, an input unit 38, and a mail box 39.

The CPU 30 controls an operation of each of the respective parts of the circuit in accordance with a program stored in the memory 32 using a hard disk or a flash memory (EEPROM), a program fetched from the storage medium 33 via the storage medium unit 34, or a program fetched from the computer terminal connected to an external communication network N via the transmission controller 36. The program executed by the CPU 30 is started according to access from other terminal apparatuses communicated via the transmission controller 36 or a manual control input from the input unit 28 having a keyboard, a mouse and the like.

The CPU 30 connects with the memory 32, the storage medium reading unit 34, the transmission controller 36, a display unit 37, and the input unit 38.

The memory 32 stores a mail managing program 32b and a present reception rejection processing program 32a for executing user setting processing, which is performed with mail management processing executed based on the mail program 32b, and present rejection processing. The memory 32 also stores various kinds of data sent from the terminal apparatus 14 managed by the mail server 18 in order to use present rejection processing, namely, present rejection condition table data 22c registered by user setting processing, address notebook data 32d (including friend notebook data 32d1, client data 32d2, black list data 32d3) which are used at the time of present rejection processing, present rejection mail format data 32e, data format 32f of an attachment file name for business as required. Additionally, the memory 32 reserves a work area for storing data, which needs temporary storage depending on the operations of processing functions of various kinds. Regarding various kinds of data used in present rejection processing, it is assumed that data, which corresponds to each terminal apparatus whose e-mail reception transmission/reception is managed by the mail server 18, is registered.

The terminal apparatus 14 whose e-mail reception transmission/reception is managed by the mail server 18 executes user setting processing as explained in the first embodiment. Then, the terminal apparatus 14 transmits present rejection condition table data 22c set in this process and data 22d to 22f used in the other present rejection processing to the mail sever 18 beforehand. The terminal apparatus 14 also instructs the mail server 18 to execute present rejection processing with respect to e-mail directing to the terminal apparatus.

In a case where execution of present rejection processing is instructed from the user of terminal apparatus 14, the mail server 18 stores e-mail (including attachment file) to the area of the mail box 39 for terminal apparatus 14 when e-mail is received to the user. The mail sever 18 also executes present rejection processing based on user's present rejection condition table data 32c and other data 32d to 32f in the same way as the first embodiment.

The mail server 18 deletes e-mail (including attachment file) determined as data to be rejected to receive from the mail box 39 so as to assure the third person that present data has not been received in such a manner that even the presence of present data to the user is not noticed. In this case, the mail server 18 may receive present data, which corresponds to the rejection condition and transit e-mail to notify the present source that data has been deleted. Also, the mail server 18 may delete only the attachment file such that the user can obtain only the mail body of e-mail.

In the second embodiment, the mail server 18 generates a return mail to notify the present source that the reception of present has been rejected. In this case, the sender of return mail (address of “FROM” shown in FIGS. 11 to 13) is the mail address of mail server 18. Accordingly, even from the sender's mail address, the present can confirm that present data has not been sent to the present destination.

In the first embodiment, processing of steps B8, B29 to B31 include processing that requests the user to make a judgment. However, in the second embodiment, these processing may not be executed (in this case, the basic rejection condition (CC) cannot be set). Also, an inquiry may be e-mailed to the terminal apparatus 14 (user) as a present source to execute processing after receiving the response.

Further, as various kinds of data pre-registered in the mail server 18 from the terminal apparatus to use present rejection processing, all data are shown as in FIG. 14, similar to in the first embodiment. However, all data are not always needed, and at least present rejection condition table data 32c may be registered. In a case where the determination whether or not the present should be rejected cannot be performed since other data is not registered, it is determined that no rejection of present is performed. This makes it possible to deal with the user, who does not wish to register personal information such as address notebook 32d to the mail server 18.

In this way, the mail server 18 executes present rejection operation of present data (e-mail attachment file) with respect to the terminal apparatus. This eliminates the need for executing present rejection processing at each terminal apparatus whose e-mail transmission/reception is managed by the mail server 18. Each terminal apparatus executes user setting processing as explained in the first embodiment to reregister present rejection condition table data set by this processing and various kinds of data used in other present rejection processing to the mail server 18. Then, execution of present rejection processing is instructed, so that the reception of present data is rejected when e-mail is received at the mail server 18. This can eliminate a troublesome problem caused by the reception of unnecessary present data completely.

### Third Embodiment

The third embodiment is next explained.

The first embodiment explained that present data as an e-mail attachment file was sent from the present source terminal apparatus 12. However, in the third embodiment, the present distribution server 15 sends present data to the present destination terminal apparatus 14 in accordance with a request (content of present, present destination) from the present source terminal apparatus 12.

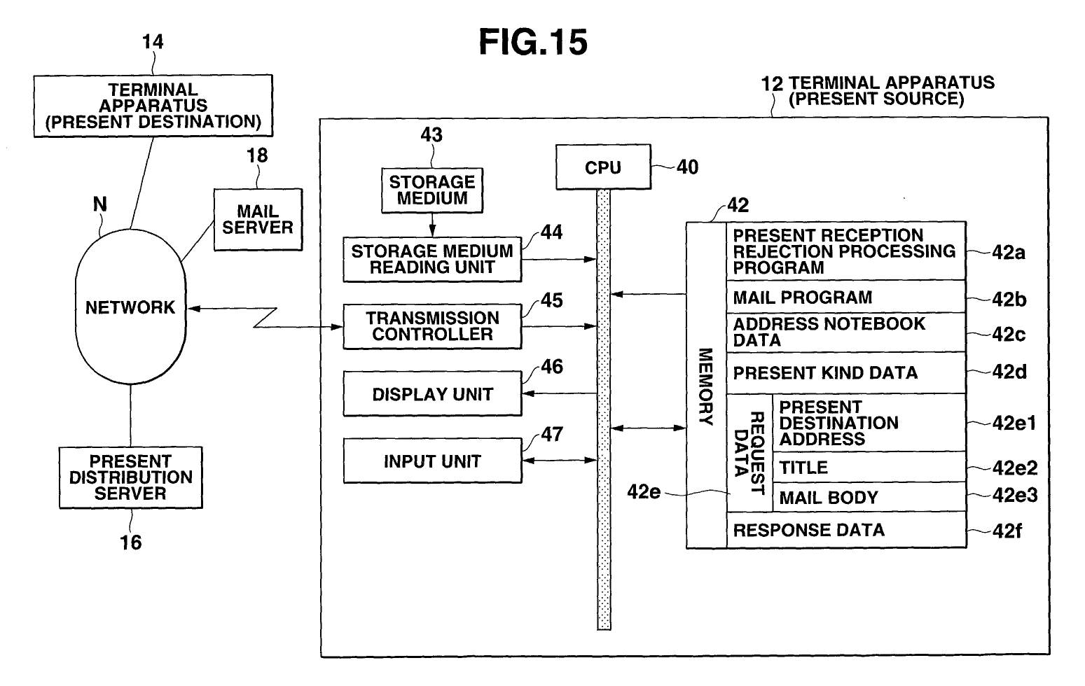

FIG. 15 is a block diagram showing the electronic circuit configuration of present source terminal apparatus 12. As shown in FIG. 15, the mail server 18 has a CPU 40, a memory 42, a storage medium 43, a storage medium reading unit 44, a transmission controller 45, a display unit 46, and an input unit 47.

The CPU 40 controls an operation of each of the respective parts of the circuit in accordance with a program stored in the memory 42 using a hard disk or a flash memory (EEPROM), a program fetched from the storage medium 43 via the storage medium unit 44, or a program fetched from the computer terminal connected to an external communication network N via the transmission controller 45. The program executed by the CPU 40 is started according to access from other terminal apparatuses communicated via the transmission controller 45 or a manual control input from the input unit 47 having a keyboard, a mouse and the like.

The CPU 40 connects with the memory 42, the storage medium reading unit 44, the transmission controller 45, a display unit 46, and the input unit 47.

The memory 42 stores a mail managing program 42b and a present reception rejection processing program 42a for executing user setting processing, which is performed with mail management processing executed based on the mail program 42b, and present rejection processing. The memory 42 also stores address notebook data 42c to which a mail address indicative of an e-mail address is registered, present kind data indicative of a kind of present, which the present distribution server 16 is requested to distribute to the present destination, request data 42e (including a present destination address 42e1, a title 42e2, a mail body 42e3) for sending information of the present destination to the present distribution server 16, and response data 42f, which is responded from the present destination terminal apparatus 14 by sending present data to the present destination via the present distribution server 16 as required. Additionally, the memory 42 reserves a work area for storing data, which needs temporary storage depending on the operations of processing functions of various kinds.

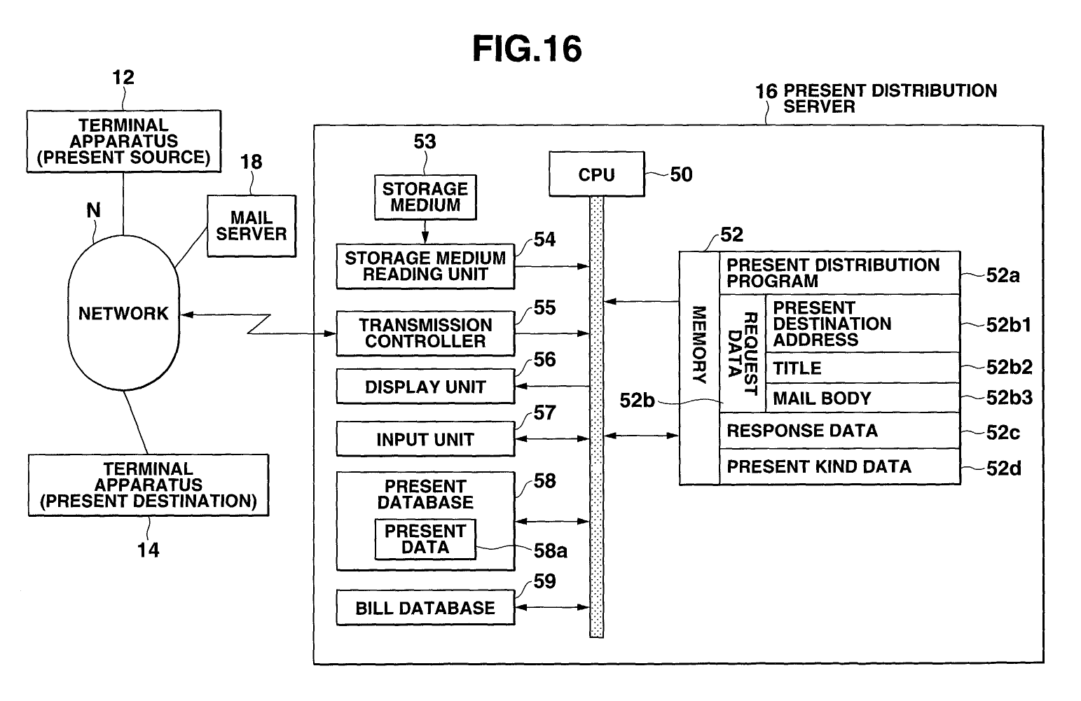

FIG. 16 is a block diagram showing the electronic circuit configuration of the present distribution server 16. As shown in FIG. 16, the mail server 18 has a CPU 50, a memory 52, a storage medium 53, a storage medium reading unit 54, a transmission controller 55, a display unit 56, an input unit 57, a present database 58, and a billing database 59.

The CPU 50 controls an operation of each of the respective parts of the circuit in accordance with a program stored in the memory 52 using a hard disk or a flash memory (EEPROM), a program fetched from the storage medium 53 via the storage medium unit 54, or a program fetched from the computer terminal connected to an external communication network N via the transmission controller 55. The program executed by the CPU 50 is started according to access from other terminal apparatuses communicated via the transmission controller 56 or a manual control input from the input unit 47 having a keyboard, a mouse and the like.

The CPU 50 connects with the memory 52, the storage medium reading unit 54, the transmission controller 55, the display unit 56, the input unit 57, the present database 58, and the billing database 59.

The memory 52 stores a present distribution program 52a for executing present distribution processing to distribute present data to a predetermined present destination in accordance with a request from the user (terminal apparatus). The memory 52 also stores request data 52b (including a present destination address 52b1, a title 52b2, a mail body 52b3) for sending information of the present destination, which is received in response to the present distribution request from the present source terminal apparatus 12, to the present distribution server 16, response data 52c, which is responded from the present destination terminal apparatus 14 by sending present data to the present destination, and present kind data 53d indicative of a kind of present to be distributed to the present destination. In addition, data shown in FIG. 15 is data stored when the request for present data distribution request is received from the terminal 12, and each data is received from each terminal apparatus and stored on a distribution request basis.

In the present database 58, various kinds of present data 58a to be distributed are registered in accordance with the present distribution request from the present source terminal apparatus 12. Present data 58 to be distributed can be identified by present kind data 52.

In the billing database 59, list data of members (name, password, mail address, etc.), who have contracted with the present distribution server 16 to use the present distribution service, (user of present source terminal apparatus 12), are stored. In the billing database, there is registered the amount of money, which is charged each member by bill processing, which is executed when the present distribution service is used.

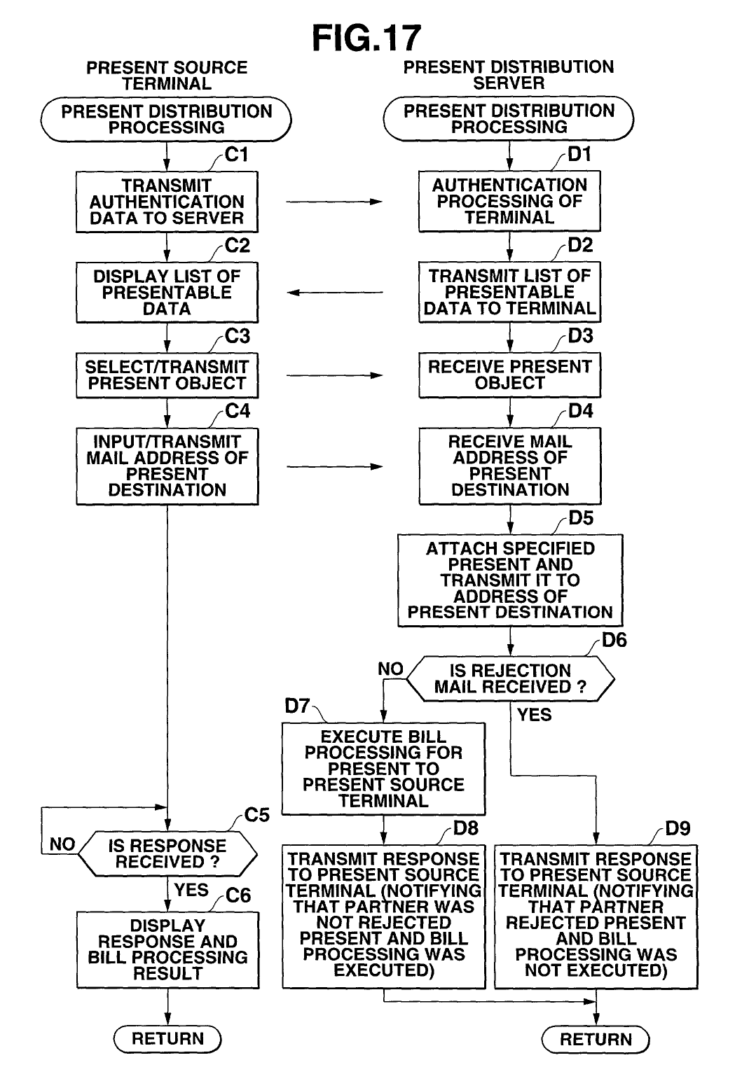

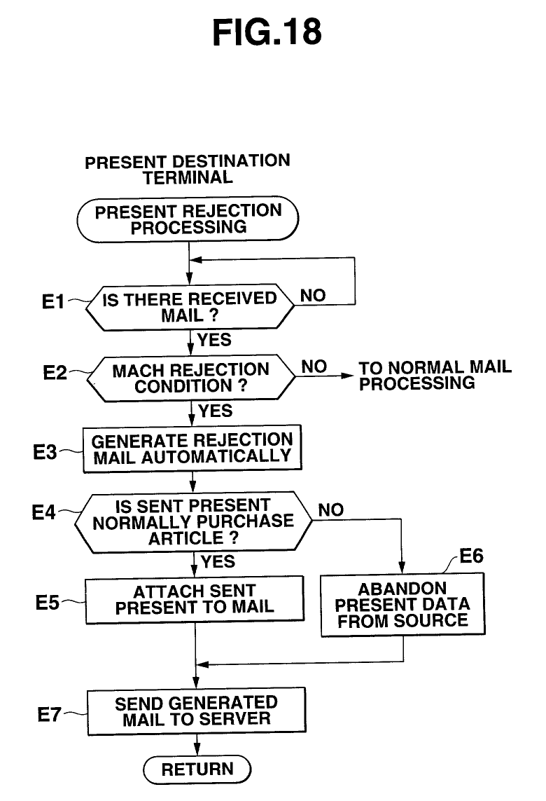

Next, an explanation is next given of operations of the present source terminal apparatus 12, present distribution server 16, and the present destination terminal apparatus 14. FIG. 17 is a flowchart showing the operations of terminal apparatus 12 and present distribution server 16, and FIG. 18 is a flowchart showing the operation of terminal apparatus 14.

The present source terminal apparatus 12 (CPU 40) starts present distribution processing by initiating the present distribution processing program 42a. First, in order to use the present distribution service offered by the present distribution server 16, the terminal apparatus 12 transmits authentication data to the present distribution server 16 to be authenticated as a member who is registered. For example, the terminal apparatus 12 sends a name or a password pre-issued at a member registering time (step C1).

When the present distribution server 16 receives authentication data from the terminal apparatus 12, the present distribution server 16 executes authentication processing based on authentication data to confirm whether or not the user is a member to which the present distribution service can be offered (step D1). When the present distribution server 16 can confirm that the user is an authenticated member by authentication processing, the present distribution server 16 transmits a list of presentable present data 58a prepared in the present database 58 to the terminal apparatus 12 (step D2).

When the terminal apparatus 12 receives the presentable data list from the present distribution server 16, the terminal apparatus 12 displays the list at the display unit 46 and instructs the user to select present data to be sent to the present destination (step C2). When present data is selected here, the terminal apparatus 12 transmits present kind data 42d to the present distribution server 16 to specify present data as an object to be presented (step C3). The present distribution server 16 receives present kind data 42d (52d) from the terminal apparatus 12, and stores it in the memory 51 temporarily.

Moreover, the terminal apparatus 12 inputs request data 42e for sending information of the present destination to the present distribution server 16, that is, the present destination address 42e1 by specification of the user, and sends it to the present distribution server 16. Additionally, in a case where present data is transmitted as an e-mail attachment file from the present distribution server 16, the title 42e2 used in e-mail and the mail body 42e3 are inputted similar to the generation of normal e-mail, and transmitted as request data 42e to the present distribution server 16. When the present distribution server 16 receives request data 52b (present destination address 52b1, title 52b2, main body 52b3), the present distribution server 16 stores it temporarily (step D4).

The present distribution server 16 generates e-mail to be transmitted to the present destination based on request data 52b. Also, the present distribution server 16 reads present data 58a specified by present kind data 52d from the present database 58, and sets the read present data 58a as an e-mail attachment file. Then, the present distribution server 16 transmits e-mail accompanied with present data 58a as an attachment file to the present destination address 52b1 (step D5).

While, the present destination terminal apparatus 14 executes the present reception rejection processing program so as to carry out present rejection processing as shown in the flowchart of FIG. 18 (steps E1 to E7). Since present rejection processing executed by the terminal apparatus 14 shown in FIG. 18 is carried out in the same processing as described in the first embodiment, and the specific explanation is omitted. However, in the third embodiment, since present data is distributed as an e-mail attachment file to the present destination terminal apparatus 14 from the present distribution server 16. For this reason, in a case where data is determined as present reception rejection by present rejection processing, a return mail indicate of reception rejection is sent to the present distribution server 16 (step E7).

While, when the present distribution server 16 distributes present data in accordance with the request from the terminal apparatus 12, with the result that the return mail indicative of reception rejection of the present is not received from the terminal apparatus 14 (step D6), the present distribution server 16 executes bill processing of the present with respect to the present source terminal apparatus 12 to update charge to the member of the terminal apparatus 12 registered in the billing database 59 (step D7). Moreover, the present distribution server 16 transmits a mail to the present source terminal apparatus 12 to send notifications in which the reception of the present has not been rejected by the communication partner as a present destination and a charge for present data has been made.

While, when the return mail indicative of reception rejection of the present is received from the terminal apparatus 14 (step D6), the present distribution server 16 transmits a mail to the present source terminal apparatus 12 to send notifications in which the reception of the present has been rejected by the communication partner as a present destination and a charge for present data has not been made (step D9).

When the present source terminal apparatus 12 receives the return mail from the present distribution server 16 (step C5), the terminal apparatus 12 displays the content of the return mail, that is, whether or not the reception of the present has been rejected by the present destination and whether or not a charge for present data has been made, and to notify the user (step C6).

In this way, according to the third embodiment, the present distribution server 16 can distribute present data specified by a predetermined present destination terminal 14 in response to the present distribution request from the terminal apparatus 12. The present distribution server 16 does not make a charge for present data to the present source terminal apparatus 12 when the reception of present is rejected by present rejection processing executed at the present destination apparatus 14. Therefore, only when present data is actually presented to the communication partner, the present source may pay a charge for present data, preventing occurrence of unnecessary expenses. The present distribution server 16 can offer higher quality service in which no unnecessary expense occurs.

In the aforementioned embodiment, as data transmitted as a present from the present source terminal apparatus 12 or present distribution server 16, an attachment file attached to e-mail is used. However, data, which is transmitted in another form, may be used. For example, by sending notification in which present data has been transmitted to the present destination and a Web page (home page) address at which present data can be received, the user at the present destination can obtain present data by accessing the sent Web page. At this time, the present destination executes present rejection processing and become able to reject the reception when data corresponds to the rejection condition. Also, the server apparatus, which manages the Web page that offers present data, obtains the rejection condition (present rejection condition table data) acquired from the present destination and executes present rejection processing based on this data, whereby present data corresponding to the rejection condition may prevent present data corresponding to the rejection condition from being obtained by the user at the present destination.

Furthermore, the above can be implemented by the same server apparatus, which is used as the mail server 18 explained in the second embodiment and the present distribution server 16 explained in the third embodiment.

The methods described in the above embodiment are stored in a recording medium such as a memory card (ROM card, RAM card, etc.), a magnetic disk (floppy disk, hard disk, etc.), an optical disk (CD-ROM, DVD, etc.), a semiconductor memory, etc., as a program that can be executed by the computer, and can be distributed. Then, the computer reads the program stored in the recording medium using the storage medium reading unit, and the operation is controlled by the read program, whereby allowing the service function of present data explained in the embodiment to be implemented and to execute the same processing as one that is carried out by the above-mentioned method.

Program data for implementing each method can be transmitted on the network N as a format of program code. Program data is fetched by the transmission controller 26 of the computer terminal connected to the network N, allowing the processing function of the aforementioned computer present service to be implemented.

### Fourth Embodiment

A fourth embodiment is next explained with reference to the drawings.

In this embodiment, the present distribution server 16 is a music distribution server 110, which distributes music data as a present, and which performs present processing of music data to a computer terminals 120a that is a present source to send a present and 120b that is a present destination.

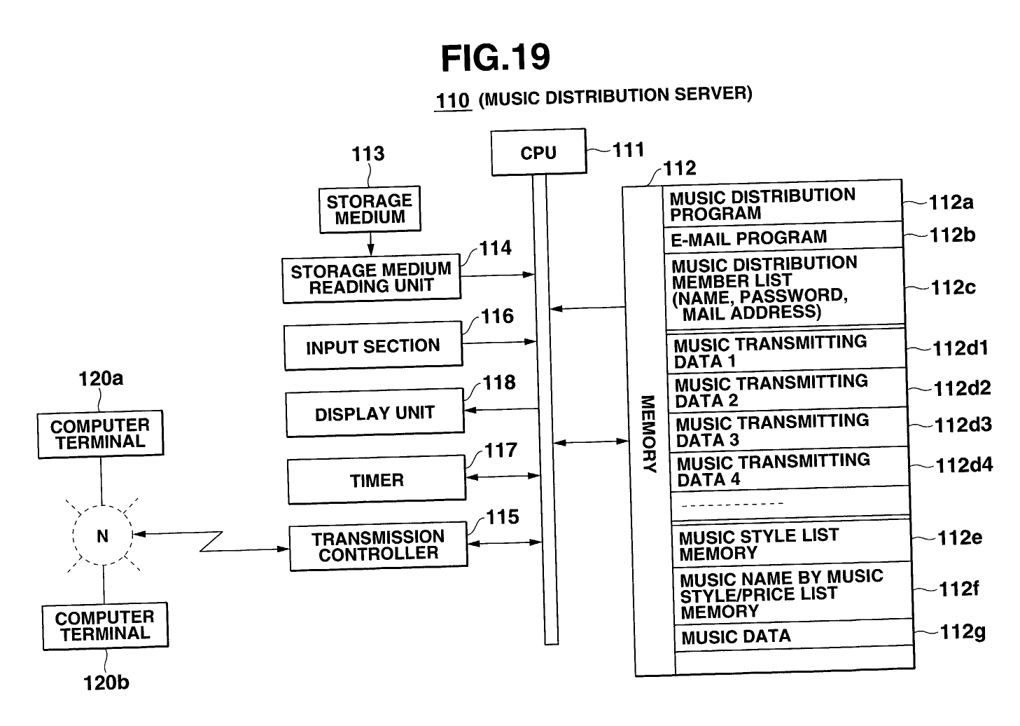

FIG. 19 is a block diagram showing an electronic circuit configuration of the server apparatus according to the fourth embodiment of the present invention.

The music distribution server 110 is connected to a public communication network N such as the Internet, and comprises a controller (CPU) 111, which is a computer.

The controller 111 (CPU) controls an operation of each of the respective parts of the circuit in accordance with a server control system program pre-stored in a memory 112 using a hard disk or a flash memory (EEPROM), a server control program fetched from a storage medium 113 such as a floppy disk etc., via a storage medium unit 114, or a server control program fetched from the computer terminal connected to an external communication network N via a transmission controller 115. These server control system program and sever control program of the music distribution server 110 are started according to server access from the respective computer terminals 120a, 120b, . . . , of a plurality of users (service users) communicated via the transmission controller 115 or a manual control input from an input unit 116 having a keyboard, a mouse and the like.

The controller (CPU) 111 connects with a timer unit 117, and a display unit 118 other than the memory 112, the storage medium reading unit 114, the transmission controller 115 and the input unit 116.

The memory 112 stores software such as a music distribution program 112a, e-mail program 112b, etc., that controls the processing functions of music present service mounted on the music distribution server 110. Additionally, the memory 112 reserves work areas for storing data, which needs temporary storage depending on the operations of processing functions of various kinds, such as a music distribution member list memory 112c, music transmitting data memories 112d1, 112d2, . . . , a music style list memory 112e, a music name by music style/price list memory 112f, a music data memory 112g, and so on.

The music distribution member list memory 112c stores list data of members contracted with the music distribution server 110 to use the present service, and the data content of each member stored as list data is composed of a name, a password, a mail address, etc.

The music transmitting data memories 112d1, 112d2, . . . store various kinds of information to perform distribution of music from the present sender to the present destination in connection with the present accessed to the music distribution server 110 memory by memory for each of the corresponding music transmitting data memories 112d1, 112d2, . . .

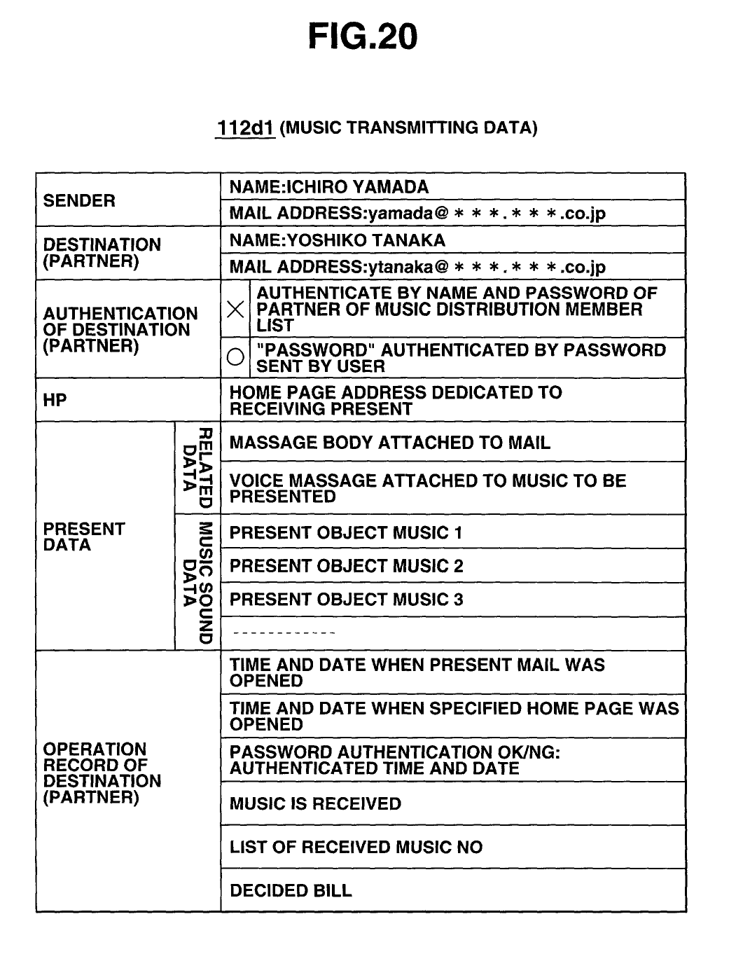

FIG. 20 is a view showing one example of the music transmitting data in the music transmitting memory of the music distribution server.

For example, one music transmitting data stored in the music transmitting data memory 112d1 has six information items of “sender”, “destination (communication partner), “authentication of destination (communication partner), “PH”, “present data”, and “operation record of destination (communication partner).”

In the item of “sender”, a name of a present sending side, and a mail address are stored.

In the item of “destination (communication partner)”, a name of a present receiving side, and a mail address are stored.

In the item of “authentication of destination (communication partner)”, a flag and a password inputted by a user are stored to determined whether authentication of the present receiving side is carried out by the name and password in the member list or the password sent from the present sending side.

In the item of “HP”, an address of a dedicated home page generated for receiving a present form the sender.

In the item of “present data”, a list of music to be presented to the destination (music list) is stored with a message body and a voice message (related data), which are inputted to the destination by the sender.

In the item of “operation record of destination (communication partner)”, there are recorded time and date when the destination opened the notification mail, time and date when the dedicated home page for receiving the present was opened, an authentication result of password and time and date of authentication, the presence or absence of present reception, list of received music Nos., and a decided bill to the sender side in accordance with the distributed music and the number of music.

In the music style list memory 112e, list data of music data types, which the music distribution server 110 has as a database, such as rock, soul, Japanese pop etc., is stored.

In the music name by music style/price list memory 112f, numerous music and the respective music names and their distribution prices, which the music distribution server 110 has as a database, are stored by music type.

In the music data memory 112g, data of numerous music, which the music distribution server 110 has as a database, is data-compressed in, for example, MPEG3 format and stored.

An explanation is next given of the processing function of music present service of the above-structured music distribution server 110.

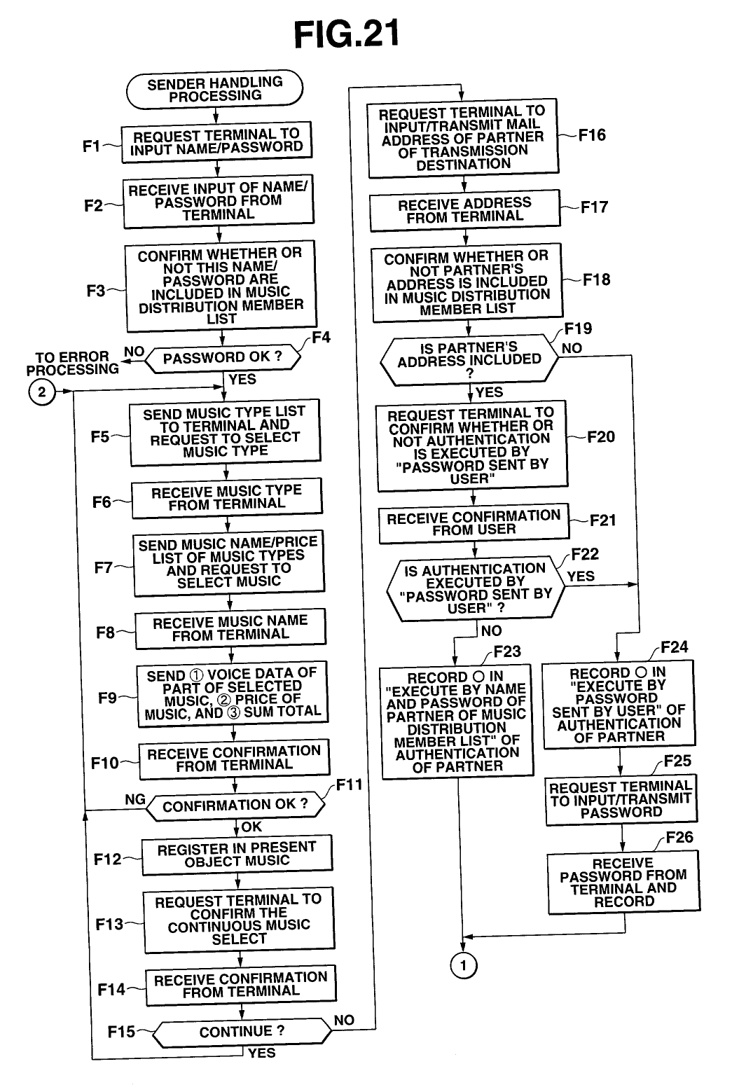

FIG. 21 is a flowchart showing sender handling processing (1) performed by the music distribution server;

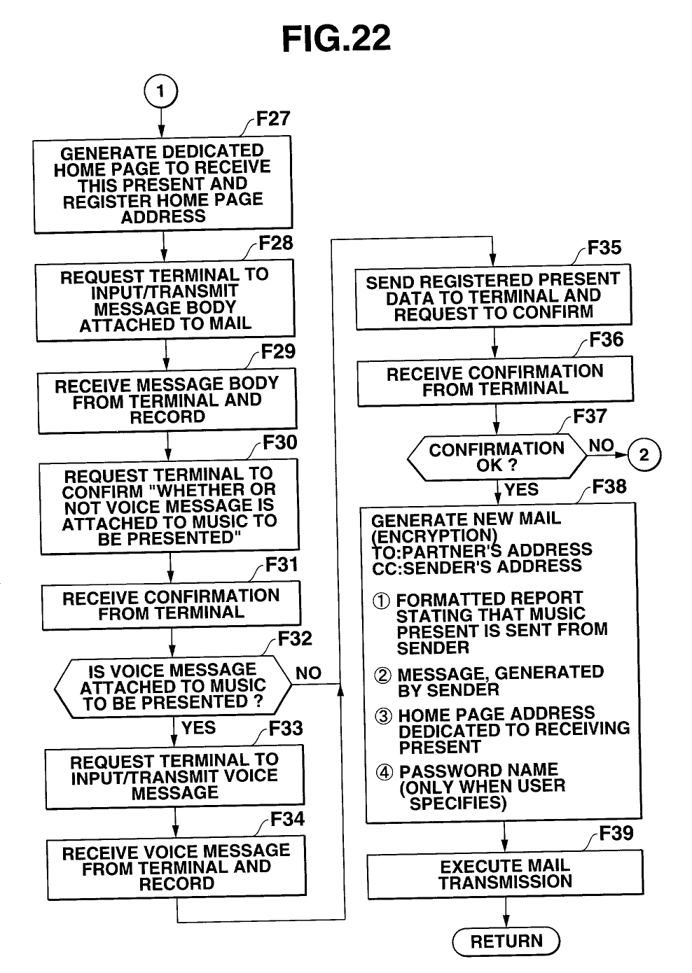

FIG. 22 is a flowchart showing sender handing processing (2) performed by the music distribution server.

The sender handling processing is started by the computer terminal 120a of the sender who accessed the music distribution home page set up by the music distribution server 110 when there is a request for present service.

First, a request for input of name and password is transmitted to the computer terminal 120a of the sender to which a request for present service is sent (step F1).

Then, when the name and password are received from the computer terminal 120a of the sender (step F2), it is verified whether or not the name and password received are registered in the member list data stored in the music distribution member list memory 112c (step F3). When the password match occurs and the password is authenticated as a member, a request for selecting the corresponding music style is transmitted to the computer terminal 120a of the sender with list data of the music styles stored in the music style list memory 112e (step F4→F5).

When the selected music style is received from the computer terminal 120a of the sender (step F6), music name by music style and price list data are read from the music name by music style/price list memory 112f and transmitted to sender's computer terminal 120a with a request for selecting a music name (step F7).

When the selected music name is received from the computer terminal 120a of the sender (step F8), voice data of a part of the music, which has been read and selected from the music data memory 112g, and a price of music, which has been read and selected from the music name by music style/price list memory 112f, and the sum total are transmitted to sender's terminal apparatus 120a (step F9).

When confirmation data of the selected music, the price, and the sum total is received from the computer terminal 120a of the sender (step F10) and it is determined that the confirmation is OK, the selected music is registered as a first present music in the item of “present data” of the music transmitting data memory 112d1(step F11→F12).

After that, a request for confirming whether or not a music selective operation should be continuously performed is transmitted to sender's computer terminal 120a (step F13).

Then, when confirmation data whether or not the next music selective operation should be continuously performed is received from sender's computer terminal 120a (step F14) and it is determined that the music selective operation is continuously performed, processing goes back to step F5 to execute processing including the style selection, music selection, confirmation of selected music, registration of the present object music, and confirmation of the next selection repeatedly in order of second music, third music, ... by data exchange with sender's computer terminal 120a (step F15→F5 to F14).

Thereafter, the present object music, which responds to the selected music desired from sender's computer terminal 120a is registered in the item of “present data” of the music transmitting data memory 112d1. Then, when confirmation data of the next music selection received from sender's computer terminal 120a is determined as confirmation data showing that no continuous music selection is performed in steps F14 and F15, a request for inputting the mail address of the partner's computer terminal 120b as a present destination is further transmitted to sender's computer terminal 120a (step F15→F16).

Then, the mail address of the computer terminal 120b as a present destination (present partner or presentee) is inputted, and transmitted from the sender's computer terminal 120a and received therefrom (step F17), it is verified whether or not the received partner's mail address is a mail address that is registered in the member list data stored in the music distribution member list memory 112c (step F18). When it is determined that the presentee's mail address is one that is registered as a member, a request for confirming whether or not authentication of the partner is performed based on a password inputted by the corresponding sender (user) is transmitted (step F19→F20).

When confirmation data of authentication method of the partner received from the sender's computer terminal 120a (step F21) is determined as confirmation data showing that authentication of the partner is not performed based on the password inputted by the sender (user), a flag, which identifies “authentication based on the name and password in the member list, is set in the item of the “authentication of sender (partner)” of the music transmitting data memory 112d1 having the present object music registered (step F22→F23).

While, it is assumed that the mail address of the partner as a present destination is not registered as a member in step F19. Or, it is assumed that confirmation data of authentication method of the partner received from the sender's computer terminal 120a is determined as confirmation data showing that authentication of the partner is performed based on the password inputted by the sender (user). A flag, which identifies “authentication based on the password sent by the user (sender)” is set in the item of the “authentication of sender (partner)” of the music transmitting data memory 112d1 having the present object music registered (step F19 or F22→F24).

After that, a request for inputting a password for authentication of partner (destination) is transmitted to the sender's computer terminal 120a (step F25). When the password for authentication of partner is received from the sender's computer terminal 120a in response to this transmission, the received password for authentication of partner is registered with the identification flag of “authentication based on the password sent by the user (user)” in the item of the “authentication of sender (partner)” of the music transmitting data memory 112d1 (step F26).

After the password registration, the computer terminal 120b o the partner (destination) prepares a web page (home page) which is exclusively for accepting the present data. URL assigned to the prepared web page is registered in the item of “HP” in the music transmitting data memory 112d1 (step F27).

Then, a request for inputting a message body to be added to the notification mail of present to be sent to the partner is transmitted to the sender's computer terminal 120a (step F28). When the message body is inputted and received from the sender's computer terminal 120a in response to this transmission, the received massage body is registered in the item of “present data” of the music transmitting data memory 112d1 (step F29).

After that, a request for confirming whether or not a voice message is attached to the present of music is transmitted to the sender's computer terminal 120a (step F30). When confirmation data of the present or absence of the voice message attachment received from the sender's terminal 120a in response to this transmission (step F31) is determined as confirmation data showing that the voice message is attached, a request for inputting a voice message to be attached to the music present to the partner is transmitted to the sender's computer terminal 120a (step F32→F33).

When the voice message is inputted and received from the sender's computer terminal 120a in response to this transmission, the received voice message is registered in the item of “present data” of the music transmitting data memory 112d1 (step F34).

Then, present data, which composed of the present object music, message body for attaching to the mail, voice message for attaching to the present, and the confirmation request are transmitted to the sender's computer terminal 120 (step F35). When confirmation data received in response to this transmission (step F36) is determined as confirmation OK, a notification mail of the present to the present destination (partner) is generated (step F37→F38).

When confirmation data received from the sender's computer terminal 120a is not OK in step F36, processing goes back to step F5, and processing for selecting and registering a user desired music is newly carried out (step F37→F5 . . .).

The notification mail of present generated in step F38 uses “TO” as a mail address of the destination (partner) and “CC” as a mail address of the sender. Then, the notification is accompanied with \mathring{1} a formatted report stating that music present is sent from the “name” of sender, \mathring{2} a message, which is generated by the sender and which is registered in the item of “present data” of the music transmitting data memory 112d1, \mathring{3} a home page address dedicated to receiving the present registered in the item of “HP” of the music transmitting data memory 112d1, and \mathring{4} a password registered in the corresponding item when the flag identifying “authentication based on the password sent by the user (sender), is set in the item of the “authentication of sender (partner)” of the music transmitting data memory 112d1. When the notification of present to the destination (partner) is thus generated, the notification mail is, for example, encrypted and transmitted to the sender computer terminal 120b (step F39).

As a result, the computer terminal 120b as a present destination can view the notification mail of present transmitted from the music distribution server 110 and confirm the presence of music present thereto, the sender's name, the message body from the sender, the home page address when receiving the present, and the password for authenticating personal identification.

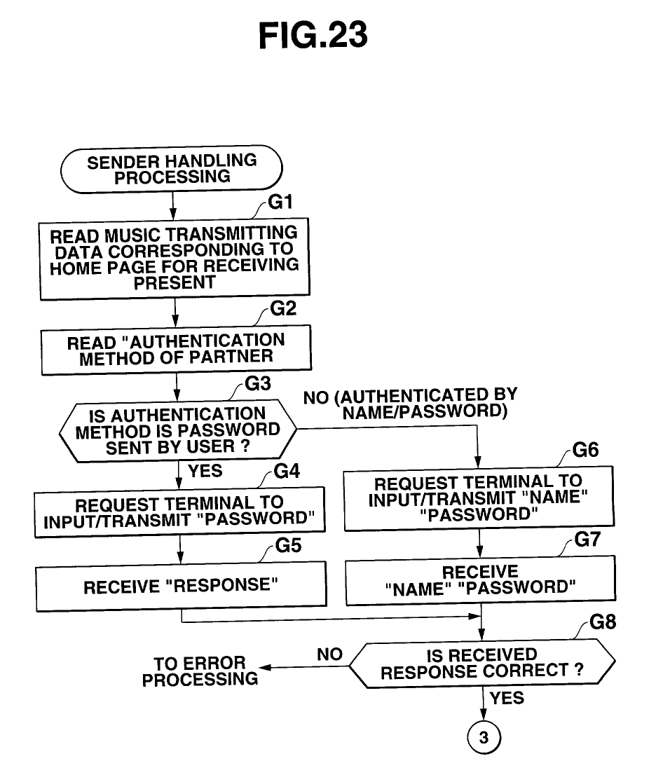

FIG. 23 is a flowchart showing destination handling processing (1) performed by the music distribution server.

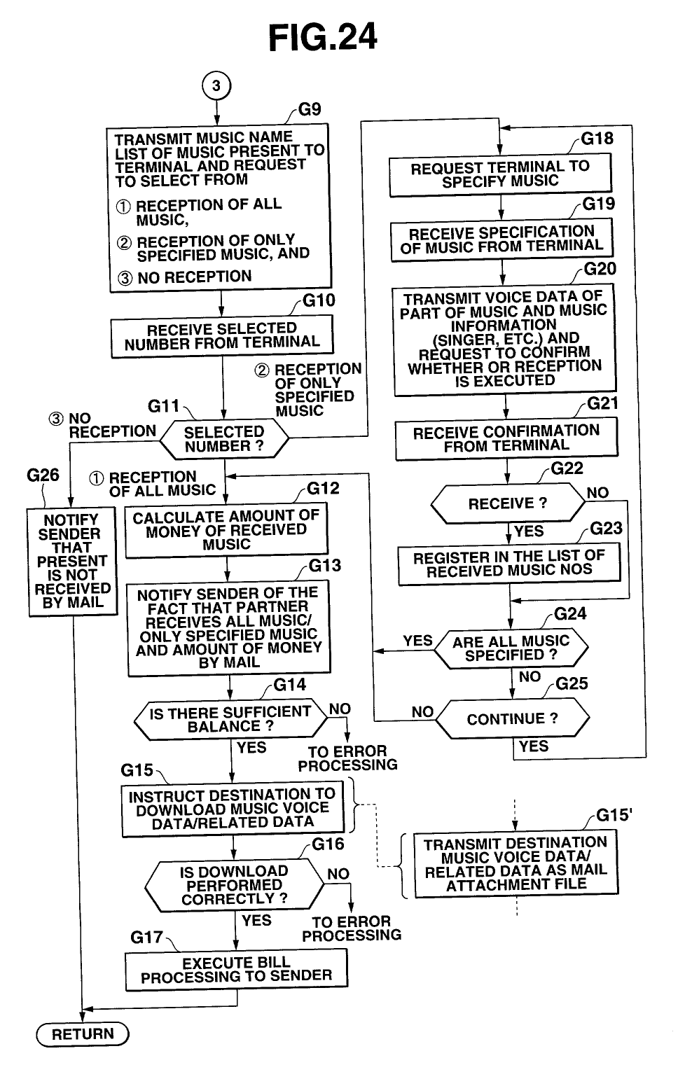

FIG. 24 is a flowchart showing destination handling processing (2) performed by the music distribution server.

This destination handling processing is started when there is access to the home page dedicated to receiving the present, which is generated by the music distribution sever 110, from the corresponding partner's (destination) computer terminal 120b in response to the notification mail of present transmitted from the music distribution server 110 to the destination computer terminal 120b. First, the music transmitting data memory 112d1, in which the address of the home page dedicated to receiving the present accessed from the destination (partner) is registered, is read and the authentication method registered in the item of “authentication of sender (partner)” by the flag (steps G1, G2).

Then, it is determined whether or not the authentication method of the destination (partner) is authentication based on the password sent from the sender (user). When it is authentication based on the password sent from the sender, a request for inputting the password described in the notification mail of present, which is already sent, is transmitted to the destination computer terminal 120b, and a reception standby state of “password”, which is a response thereto, is set (step G3→G4, G5).

While, when the authentication method of the destination (partner) read from the music transmitting data memory 112d1 (step G2) is determined as authentication based on the name and password registered in the member list and not authentication based on the password sent from the sender (user), a request for inputting the name and member password is transmitted to the destination computer terminal 120b, and a reception standby state for “name” and “password”, which are inputted and transmitted from the destination computer terminal 120b in response to this transmission, is set (step G3→G6, G7).

Then, in the reception standby state of step G5, there is a case in which the “password” received from the destination computer terminal 120b matches the “password”, which is registered in the item of “authentication of destination (partner)” of the music transmitting data memory 112d1 and which is inputted by the sender, whereby authenticating that destination (partner) is correct (steps G5, G8). Or, in the reception standby state of step G7, there is a case in which the “name” and “password” received from the destination computer terminal 120b match the “name” and “password” of any one of the members registered in the music distribution member list memory 112c, whereby authenticating that destination (partner) is correct (steps G5, G8). In either case, a request for selecting any one of “\mathring{1} reception of all music”, “\mathring{2} reception of only specified music”, and “\mathring{3} no reception” is transmitted to the authenticated destination (partner) computer terminal 120b with the list of the present object music registered in the item of “present data” of the music transmitting data memory 112d1 (step G8→G9).

When the selection number received from the destination (partner) computer terminal 120b in response to this transmission (step G10) is determined as “\mathring{1} reception of all music”, the amount of money in the case of reception (distribution) of all music is calculated from the respective music names and prices stored in the music name by music style/price list memory 112f based on the present object music, each content, and the number of music (step G11→G12). The point that the destination (partner) receives all music as a present, and the necessary amount of money to the sender are mailed and notified to the sender's computer terminal 120a (step G13).

In this case, in the item of “operation record of destination (communication partner)” of the music transmitting data memory 112d1, there are recorded the opening time and date of the present notification mail, and, access time and date of the dedicated home page for receiving the present, an authentication result of password and time and date of authentication, the presence or absence of present reception, list of received music Nos., and a decided bill to the sender.

Here, the balance of the sender registered in the music distribution member list memory 112c is checked. Then, when it is confirmed that there is a sufficient balance more than the necessary amount of money notified to the sender, the voice message, which is registered in the item of “present data” of the music transmitting data memory 112d1, and voice data, which is read from the music data memory 112g in accordance with the respective present object music 1, 2, . . . , are downloaded or transmitted an e-mail attachment file to the destination (partner) computer terminal 120b, which is a presentee (step G14→G15 or G15′).

Then, when it is confirmed that transmission of present data is normally performed to the destination (partner) computer terminal 120b by downloading or mailing, bill processing is executed to the sender registered in the member list 112c (step G16→G17).

When the selection number received from the destination (partner) computer terminal 120b in step G10 is determined as “\mathring{2} reception of only specified music”, a request for specifying music to be desirably received is transmitted to the sender's computer terminal 120b (step G11→G18).

When specified data of music to be desirably received in the list of the present object music is received from the destination (partner) computer terminal 120b (step G19) in response to this transmission, a request for confirming the presence or absence of receiving this music is transmitted to the destination (partner) computer terminal 120b with sound information of a part of the specified music stored in the music data memory 112g and music information of a signer (step G20).

Then, when confirmation data of the reception of specified music is received from the destination (partner) computer terminal 120b (step G19), the specified music No. is registered in the list of received music Nos. in the item operation record of destination (partner) of the music transmitting memory 112d1 (step G21, G22→G23).

After that, it is determined whether or not the confirmation of receiving the sender's (partner) specification of music from the list of the present object music and the registration are performed to all object music (step G24). When the confirmation of all object music is not finished, processing goes back to step G18, and a request for specifying the other music to be desirably received is repeatedly transmitted to the destination (partner) computer terminal 20b (step G24→G25→G18).

Then, the repetition of processing in steps G18 to 25 executes the specification and confirmation of music to be desirably received in the list of present object music transmitted to the destination (partner) computer terminal 120b and the registration processing, sequentially. Thereafter, there is a case in which the confirmation of receiving the sender's (partner) specification of music and the registration are performed to all object music in the step G24. Or, there is a case in which confirmation data, which shows that operation of specifying the corresponding music is stopped, is transmitted from the destination computer terminal 120b in the step G25. In either case, the amount of money in the case of reception (distribution) of only the specified music is calculated from the respective music names and prices stored in the music name by music style/price list memory 112f based on the list of received music Nos., the each content, and the number of music registered in the item of the “operation record of sender (partner) of the music transmitting data memory 112d1 (step G24 or G25→G12). The point that the destination receives only the specified music from the present and the necessary amount of money to the sender are mailed and notified to the sender's computer terminal 120a (step G13).

In this case, in the item of “operation record of destination (communication partner)” of the music transmitting data memory 112d1, there are recorded the opening time and date of the present notification mail, and, access time and date of the dedicated home page for receiving the present, an authentication result of password and time and date of authentication, the presence or absence of present reception, list of received music Nos., and a decided bill to the sender.

Here, the balance of the sender registered in the music distribution member list memory 112c is checked. Then, when it is confirmed that there is a sufficient balance more than the necessary amount of money notified to the sender, the voice message, which is registered in the item of “present data” of the music transmitting data memory 112d1, and voice data, which is read from the music data memory 112g in accordance with the respective present object music 1, 2, . . . , are downloaded or transmitted an e-mail attachment file to the destination (partner) computer terminal 120b, which is a presentee (step G14→G15 or G15′).

Then, when it is confirmed that transmission of present data is normally performed to the destination (partner) computer terminal 120b by downloading or mailing, bill processing is executed to the sender registered in the member list 112c (step G16→G17).

When the selection number received from the destination (partner) computer terminal 120b in step G10 is determined as “\mathring{3} no reception”, notification stating that the destination (partner) does not receive the present is e-mailed to the corresponding the sender's computer terminal 120b (step G11→G26).

According to the processing function of the music present service offered from the above-structured music distribution server 110, the sender's computer terminal 120a accessed to the music distribution server 110 is instructed to select a desirable music name to be presented from numerous music names of a plurality of types stored in the music type list memory 112e and the music name by music style/price list memory 112f and to specify the mail address of the destination computer terminal 120b. As a result, the home page dedicated to receiving the present to the destination computer terminal 120b is generated, and the address of the dedicated home page is mailed to the destination computer terminal 120b. Then, when access to the dedicated home page from the destination computer terminal 120b is gained, music (music sound) data, which corresponds to the music name selected from the sender, is read from the music data memory 112g, which stores numerous music data of all types of music, and is downloaded or transmitted as an e-mail attachment file to be presented. While, the amount of money for music distribution corresponding to the present music is calculated based on the distribution of each music stored in the music name by music style/price list memory 112f, and is billed the sender. This makes it possible to not only enjoy desired music by oneself but also send it to a third person's computer terminal via the music distribution server 110.

Moreover, according to the processing function of the music present service offered from the above-structured music distribution server 110, when access to the dedicated home page from the destination computer terminal 120b is gained, the destination is instructed to specify another desirable music name from numerous music names selected by the sender, and only music data specified by the destination is read from the music data memory 112g, and is downloaded or transmitted as an e-mail attachment file to be presented. While, the amount of money for music distribution corresponding to only the music, which is specified by the destination and presented, is calculated based on the distribution of each music stored in the music name by music style/price list memory 112f, and the sender is billed for the amount. This makes it possible for the destination, which is the present receiving side, to specify only the desired music from music selected by the sender and to receive it as a present.

Furthermore, according to the processing function of the music present service offered from the above-structured music distribution server 110, the presence or absence of present data reception by the destination, and the list of received music Nos. are recorded in the “operation record of destination (partner)” and sent to the sender's computer terminal 120a. This makes it possible for the sender to know how the music present sent by the sender has been received by the destination.

In this case, the destination can specify that any music be received. In this case, notification stating that the present is not received is sent to the sender, and the sender is not billed. Namely, the destination can reject the reception of present appropriately without putting an unnecessary load on the sender. Notification of the rejection is sent to the sender, so that the sender can execute an appropriate action, and unnecessary expenses do not occur.

According to the processing function of the music present service offered from the above-structured music distribution server 110, at the time of instructing the sender to select the music name to be presented and the destination to specify a desirable music selected by the sender, music data of a part of the music as a selection object is transmitted to the sender's computer terminal 120a to confirm the presence or absence of the registration of music as a present, and music data of a part of the music as a selection object is transmitted to the destination computer terminal 120b to confirm the presence or absence of the reception. This makes it possible to decide the selection or specification after viewing the part of music in either case when the sender selects the music to be desirably presented and when the destination specify the music to be desirably received.

Moreover, according to the processing function of the music present service offered from the above-structured music distribution server 110, when the sender select the music to be presented, the voice message is inputted, and when voice data of the music corresponding to the music selected by the sender is downloaded or mailed as present data, the voice message inputted by the sender is incorporated into the present data and downloaded or mailed. This makes it possible for the sender to transmit the present data in which the sender's voice message is added to the desired music data to the destination.

In the fourth embodiment, present object data is explained as music data. However, data of all kinds such as a book, a move, photograph, game software (computer program), may be converted to character data, image data, voice data, and code data as present object data.

The methods described in the fourth embodiment, namely, sender handling processing shown by the flowcharts of FIGS. 21 and 22 and destination handling processing shown by the flowcharts of FIGS. 23 and 23 with the processing function of the music present service offered by the music distribution server 110 are stored in the recording medium such as a memory card (ROM card, RAM card, etc.), a magnetic disk (floppy disk, hard disk, etc.), an optical disk (CD-ROM, DVD, etc.), a semiconductor memory, etc., as a program that can be executed by the computer, and can be distributed. Then, the computer reads the program stored in the storage medium 113 using the storage medium reading unit 114, and the operation is controlled by the read program, whereby allowing the service function of present data explained in the embodiment to be implemented and to execute the same processing as one that is carried out by the above-mentioned method.

Program data for implementing each method can be transmitted on the network N as a format of program code. Program data is fetched by the transmission controller 15 of the computer terminal connected to the network N, allowing the processing function of the aforementioned computer present service to be implemented.

Various embodiments and changes may be made thereunto without departing from the broad spirit and scope of the invention. The above-described embodiments are intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention.

This application is based on Japanese Patent Application Nos. H11-374626 filed on Dec. 28, 1999 and 2000-271961 filed on Sep. 7, 2000, and including specification, claims, drawings and summary. The disclosure of the above Japanese Patent Application is incorporated herein by reference in its entirety.

What is claimed is:

1. A terminal apparatus, which receives data transmitted from a sender via a network, comprising:
extracting means for extracting data of a predetermined format among from data transmitted from said sender;
rejection condition setting means for storing a rejection condition for rejecting the reception of the extracted data of the predetermined format by said extracting means;
determining means for determining whether or not the reception of said extracted data is rejected based on said rejection condition set by said rejection condition setting means; and
rejecting means for rejecting the reception of said extracted data transmitted from said sender when the reception of said extracted data is rejected by said determining means.

2. The terminal apparatus according to claim 1, further comprising business data format storage means for storing a business data format, wherein said extracting means extracts data other than the data format stored in said business data format storage means as data of the predetermined format.

3. The terminal apparatus according to claim 1, wherein the rejection condition set by said rejection condition setting means include a condition with respect to the sender of said extracted data.

4. The terminal apparatus according to claim 1, wherein the rejection condition set by said rejection condition setting means include a condition with respect to the kind of said extracted data.

5. A terminal apparatus, which receives data transmitted from a sender via a network, comprising:
detecting means for detecting that data is transmitted from said sender;
information obtaining mans for obtaining information of data detected by said detecting means;
information displaying means for displaying information obtained by said information obtaining means;
instruction inputting means for inputting an instruction whether or not the reception of said data is rejected in accordance with information displayed by said information displaying means; and
rejecting means for rejecting the reception of data transmitted from said sender when the instruction to reject the reception is inputted by said instruction inputting means.

6. The terminal apparatus according to claim 1, further comprising reception rejection notifying means for notifying the sender of data that the reception is rejected when the reception of data is rejected by said rejecting means.

7. The terminal apparatus according to claim 1, further comprising data abandoning means for abandoning data transmitted from said sender when the reception of data is rejected by said rejecting means.

8. The terminal apparatus according to claim 1, further comprising data returning means for returning data transmitted from said sender to said sender when the reception of data is rejected by said rejecting means.

9. The terminal apparatus according to claim 1, wherein data transmitted from said sender is an attachment file attached to e-mail.

10. A computer-readable recording medium having a reception rejection processing program recorded thereon, said recording medium having a program for operating a computer recorded thereon to receive data transmitted from a sender via a network, and said reception rejection processing program causing said computer to execute procedures for:
extracting means for extracting data of a predetermined format among from data transmitted from said sender;
storing a rejection condition for rejecting the reception of the extracted data of the predetermined format by said extracting procedure;
determining whether or not the reception of said extracted data is rejected based on said rejection condition stored by said rejection condition storing procedure; and
rejecting the reception of said extracted data transmitted from said sender when the reception of said extracted data is rejected by said determining procedure.

11. A data reception method for receiving data transmitted from a sender via a network, comprising the steps of:
extracting data of a predetermined format among from data transmitted from said sender;
storing a rejection condition for rejecting the reception of the extracted data of the predetermined format by said extracting means;
determining whether or not the reception of said extracted data is rejected based on said rejection condition set by said rejection condition setting means; and
rejecting the reception of said extracted data transmitted from said sender when the reception of said extracted data is rejected by said determining means.

12. A computer-readable recording medium having a reception rejection processing program recorded thereon, said recording medium having a program for operating a computer recorded thereon to receive data transmitted from a sender via a network, and said reception rejection processing program causing said computer to execute procedures for:
detecting that data is transmitted from said sender;
obtaining information of data detected by said detecting procedure;
displaying information obtained by said information obtaining procedure;
inputting an instruction whether or not the reception of said data is rejected in accordance with information displayed by said information displaying procedure; and
rejecting the reception of data transmitted from said sender when the instruction to reject the reception is inputted by said instruction inputting procedure.

13. A server apparatus, which receives data to a predetermined destination transmitted from a sender via network, comprising:
rejection condition obtaining means for obtaining a rejection condition for rejecting the reception of data, which is transmitted from the sender, from said destination;
determining means for determining whether or not the reception of data transmitted from said sender is rejected based on the rejection condition set by said rejection condition obtaining means; and
rejecting means for rejecting the reception of data transmitted from said sender when the reception of data is rejected by said determining means.

14. The server apparatus according to claim 13, further comprising reception rejection notifying means for notifying the sender of data that the reception is rejected when the reception of data is rejected by said rejecting means.

15. A computer-readable recording medium having a reception rejection processing program recorded thereon, said recording medium having a program for operating a computer recorded thereon to receive data to a predetermined destination transmitted from a sender via a network, and said reception rejection processing program causing said computer to execute procedures for:
obtaining a rejection condition for rejecting the reception of data, which is transmitted from the sender, from said destination;
determining whether or not the reception of data transmitted from said sender is rejected based on the rejection condition set by said rejection condition obtaining procedure; and
rejecting the reception of data transmitted from said sender when the reception of data is rejected by said determining procedure.

16. A data reception method for receives data to a predetermined destination transmitted from a sender via network, comprising the steps of:
obtaining a rejection condition for rejecting the reception of data, which is transmitted from the sender, from said destination;
determining whether or not the reception of data transmitted from said sender is rejected based on the rejection condition set by said rejection condition obtaining means; and
rejecting the reception of data transmitted from said sender when the reception of data is rejected by said determining means.

17. A server apparatus, which transmits data selected by a sender to a specified destination, comprising:
data storage means for storing a plurality of data;
data selection requesting means for requesting said sender to select desired data among from the plurality of data stored in said data storage means;
destination specification requesting means for requesting said sender to specify a destination;
data transmitting means for transmitting data selected by said sender using said data selection requesting means to the destination specified by said destination specification requesting means; and
response receiving means for receiving a response of a reception rejection from said destination when said destination to which data is transmitted by said data transmitting means rejects the reception of data.

18. The server apparatus according to claim 17, further comprising billing means for demanding a bill for the amount of amount, which corresponds to data transmitted to said destination, from said sender when no response of the reception rejection is received by said response receiving means and for demanding no bill when the response of the reception rejection is received by said response receiving means.

19. The server apparatus according to claim 18, further comprising notifying means for notifying said sender that the reception of data is unrejected and that the bill is demanded when the bill is demanded by said billing means, and for notifying said sender that the reception of data is rejected when no bill is demanded by said billing means.

20. A computer-readable recording medium having a reception rejection processing program recorded thereon, said recording medium having a program for operating a computer recorded thereon to transmit data selected by a sender to a specified destination via a network, and said reception rejection processing program causing said computer to execute procedures for:
storing a plurality of data;
requesting said sender to select desired data among from the plurality of data stored by said storing procedure;
requesting said sender to specify a destination;
transmitting data selected by said sender using said data selection requesting procedure to the destination specified by said destination specification requesting procedure; and
receiving a response of a reception rejection from said destination when said destination to which data is transmitted by said data transmitting procedure rejects the reception of data.

21. A server apparatus, which offers service of presenting data selected by a sender to a specified destination via a network, comprising:
data storage means for storing a plurality of data;
data selection requesting means for requesting said sender to select desired data among from said plurality of data stored in said data storage means;
destination specification requesting means for requesting said sender to specify a destination;
data obtaining area setting means for setting a data obtaining area dedicated to the destination specified in accordance with said destination specification requesting means;
data obtaining area notifying means for notifying said destination of said data obtaining area set by said data obtaining area setting means;
reception selection requesting means for requesting the corresponding destination to select whether or not data is received in response to access to said data obtaining area set by said data obtaining area setting means from said destination; and
received content notifying means for notifying said sender of the selected content of whether or not data, which is selected by said destination in accordance with said reception selection requesting means, is received.

22. The server apparatus according to claim 21, further comprising data obtaining means for causing the corresponding destination to obtain data selected by said destination in accordance with said data selection requesting means in response to the reception of the selected content in which data, which is selected by said destination in accordance with said reception selection requesting means, is received.

23. The server apparatus according to claim 22, further comprising billing means for demanding a bill for the amount of money, which corresponds to obtained data, from said sender when said destination obtains data by said data obtaining means.

24. The server apparatus according to claim 22, wherein said data obtaining means has data specification requesting means for requesting the corresponding destination to specify desired data among data selected in accordance with said data selection requesting means in response to access to said data obtaining area set by said data obtaining area setting means from said destination, and for causing said destination to obtain only data specified in accordance with said data specification requesting means, and said billing means demands a bill for the amount of money, which corresponds to the specified and obtained data, from said sender when data specified by said destination is obtained by said data obtaining means.

25. The server apparatus according to claim 22, wherein said data selection requesting means has sender data pre-obtaining means for causing said sender to obtain a part of data as a selective object among from the plurality of data stored in said data storage means before deciding the selection.

26. The server apparatus according to claim 22, wherein said data selection requesting means has destination data pre-obtaining means for causing said destination to obtain a part of data as a specified object among from the plurality of data selected in accordance with said data selection requesting means before deciding the specification.

27. The server apparatus according to claim 22, further comprising transmission requesting means for requesting said sender to transmit sender's own creative data, wherein said data obtaining means for causing the corresponding destination to obtain the creative data transmitted from said sender in accordance with said transmission requesting means with data selected in accordance with said data selection requesting means in response to access to said data obtaining area set by said data obtaining area setting means from said destination.

28. The server apparatus according to claim 22, further comprising voice transmission requesting means for requesting said sender to transmit sender's own voice data, wherein said data is music sound data, and said data obtaining means for causing the corresponding destination to obtain a pair of data, which includes one or a plurality of music sound data selected in accordance with said data selection requesting means and voice data transmitted from the sender in accordance with said voice transmission requesting means, in response to access to said data obtaining area set by said data obtaining area setting means from said destination.

29. The server apparatus according to claim 22, wherein said service is service, which is performed in response to access to a predetermined home page from a terminal, the data obtaining area set by said data obtaining area setting means is a home page area with a home page dedicated to the destination, and said obtain area notifying means is notifying means for notifying the destination of a dedicated home page address of said home page area.

30. A computer-readable recording medium having a present service processing program recorded thereon, said recording medium having the service processing program for causing a computer to execute service, which presents data selected by a sender to a specified destination via a network, recorded thereon, and said service processing program causing said computer to execute procedures for:
storing a plurality of data in a data memory;
requesting said sender to select desired data among from the plurality of data stored in said data memory;
requesting said sender to specify a destination;
setting a data obtaining area dedicated to the destination specified in accordance with said destination specification requesting procedure;
notifying said destination of said data obtaining area set by said data obtaining area setting procedure;
requesting the corresponding destination to select whether or not data is received in response to access to said data obtaining area set by said data obtaining area setting procedure from said destination; and
notifying said sender of the selected content of whether or not data, which is selected by said destination in accordance with said reception selection requesting procedure, is received.

31. A service offering method for offering service of presenting data selected by a sender to a specified destination via a network, comprising the steps of:
storing a plurality of data;
requesting said sender to select desired data among from said plurality of data stored in said data storage means;
requesting said sender to specify a destination;
setting a data obtaining area dedicated to the destination specified in accordance with said destination specification requesting means;
notifying said destination of said data obtaining area set by said data obtaining area setting means;
requesting the corresponding destination to select whether or not data is received in response to access to said data obtaining area set by said data obtaining area setting means from said destination; and
notifying said sender of the selected content of whether or not data, which is selected by said destination in accordance with said reception selection requesting means, is received.
